(19) United States
(12) Patent Application Publication
(10) Pub. No.: US 2025/0225781 A1
(43) Pub. Date: Jul. 10, 2025

(54) EFFICIENTLY PERFORMING INFERENCE COMPUTATIONS OF A FULLY CONVOLUTIONAL NETWORK FOR INPUTS WITH DIFFERENT SIZES

(71) Applicant: Google LLC, Mountain View, CA (US)

(72) Inventors: Tushar Kumar, San Francisco, CA (US); Soorgoli Ashok Halambi, Cupertino, CA (US); Jason Jong Kyu Park, San Jose, CA (US); Arun Chauhan, Belmont, CA (US); Dong Hyuk Woo, San Jose, CA (US)

(21) Appl. No.: 18/701,867

(22) PCT Filed: Oct. 25, 2021
(86) PCT No.: PCT/US2021/056418

§ 371 Date: Apr. 16, 2024

(51) Int. Cl. G06V 10/82; G06V 10/10; G06V 10/26

(52) U.S. Cl. CPC G06V 10/82; G06V 10/16; G06V 10/26

(57) ABSTRACT

Methods, systems, and apparatus, including computer programs encoded on computer storage media, for performing inference computations of a fully convolutional neural network receiving inputs with different sizes. One of the methods include receiving a new input to be processed by a fully convolutional neural network, the new input having a first size different from a fixed size that the fully convolutional neural network is configured to process; determining, one or more fixed-size inputs from the new input, each fixed-size input having the fixed size; obtaining a respective fixed-size output generated by the fully convolutional neural network performing inference computations for each of the one or more fixed-size inputs; and generating, from the respective fixed-size outputs comprising one or more invalid pixel values, a final output that is equivalent to an output that would be generated by processing the new input using the fully convolutional neural network.

### BACKGROUND

This specification relates to neural networks. In particular, this specification relates to efficiently performing inference computations of a fully convolutional network which receives inputs with different sizes.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of network parameters.

A fully convolutional network is a neural network that includes only convolutional neural network layers and, optionally, other layers that are made up solely of components that only operate on local input regions, e.g., pooling layers and element-wise layers, e.g., those that apply an element-wise non-linear activation function. Specifically, unlike other types of convolutional neural networks, a fully convolutional network does not have any fully connected layers. A fully convolutional network can be configured to make pixel-wise predictions of an input (e.g., an image with a plurality of pixels). In other words, the fully convolutional network can be used to make a respective prediction for each pixel of the input. An example of a task that requires making pixel-wise prediction is image segmentation, in which a neural network is configured to generate, for each pixel of the input image, a respective score for each of multiple classes.

### SUMMARY

This specification generally describes techniques for performing inference computations of a neural network.

According to an aspect, the described techniques relate to a method performed by one or more computers. The method comprises receiving a new input to be processed by a fully convolutional neural network deployed on a hardware accelerator, determining, one or more fixed-size inputs from the new input; providing each of the one or more fixed-size inputs to the hardware accelerator for performing inference computations using the fully convolutional neural network; obtaining, from the hardware accelerator, a respective fixed-size output generated by the fully convolutional neural network for each of the one or more fixed-size inputs; and generating, from the respective fixed-size outputs, a final output that is equivalent to an output that would be generated by processing the new input using the fully convolutional neural network. The new input has a first size that is different from a fixed size that the fully convolutional neural network is configured to process when deployed on the hardware accelerator. Each of the one or more fixed-size input has the fixed size. The respective fixed-size outputs have one or more inaccurate pixel-wise results.

The subject matter described in this specification can be implemented in particular embodiments so as to realize one or more of the following advantages.

The described techniques allow a statically compiled fully convolutional network model deployed on a hardware accelerator to process input data with unknown or varying sizes. In general, while a fully convolutional neural network can in principle process inputs of any arbitrary size, a statically compiled neural network that has already been deployed on a hardware accelerator cannot process input with varying sizes. Additionally, it is difficult to compile a neural network for deployment on a hardware accelerator that is dynamically capable of processing input data with unknown or varying sizes. However, the described techniques can efficiently tile input data into a plurality of smaller fixed-size inputs and provide the inputs for performing inference computations of a statically compiled fully convolutional network.

The described techniques can also stitch together generated fixed-size outputs to produce a final output for a given input of a random size that is equivalent to the output that would have been generated by the fully convolutional network processing the random-sized input. Thus, the described techniques allow a fully convolutional network compiled only to accept inputs of a fixed size when deployed on a hardware accelerator to generate accurate outputs for inputs of different sizes without modifying the compiled model or the operation of the hardware accelerator.

Additionally, the described techniques can automatically generate, based on the characteristics of a fully convolutional network, optimized parameters for tiling and stitching inputs and outputs for the network. Using these optimized parameters, the described techniques can improve computation efficiency in performing inference computations for input data with unknown or varying sizes.

The described techniques can perform inference operations of different tiles (e.g., fixed-size inputs) in parallel, taking advantage of the data sharing properties between adjacent accelerators to decrease memory usage. For example, the described techniques can optimize data transfer across overlapping regions of adjacent fixed-size inputs according to the input or output data with various sizes.

Furthermore, the described techniques are robust to different input sizes and hardware accelerator architectures. The described techniques can automatically identify hardware constraints or requirements, such as system memory bandwidth. The described techniques can efficiently tile arbitrary large-size inputs to fit a fully convolutional network deployed on the hardware accelerator based on the identified hardware constraints or requirements. The system can also robustly process inputs, having sizes smaller than the fixed size for the fully convolutional network, by padding zeros around the inputs to reach the fixed size.

For example, for accelerators with advanced memory addressing capabilities (e.g., accelerators including direct memory access (DMA) engines), the described techniques can reduce or eliminate overhead time related to data manipulation for tiling inputs and stitching fixed-size outputs. As another example, for accelerators with simpler architecture or less memory bandwidth, the described techniques can perform operations for a single model at a time. In some implementations, the described techniques can determine whether there are accelerator arrays in a computation system, and in response to determine there are accelerator arrays, the described techniques can perform inference operations of different tiles in parallel, taking advantage of the data sharing properties between adjacent accelerators to decrease memory usage.

Moreover, the techniques described in this specification are distinct and advantageous over conventional data parallelization techniques. In general, data parallelization techniques can divide input data (e.g., an input image) into multiple disjoint portions (e.g., segments of the input image) and assign the multiple portions to multiple hardware components (e.g., hardware accelerators) to process the portions independently and in parallel to generate partial outputs. After all of the portions are processed by the hardware components, a system configured to perform the data parallelization techniques can generate a final output by aggregating the partial outputs. As long as the operations are correctly performed by each hardware component for respectively designated portions, the system does not need to consider whether any parts of the partial outputs are not suitable or inaccurate for generating the final output.

However, in general, a fully convolutional network generally does not take advantage of data parallelization techniques because an output generated by the fully convolutional network processing a portion of an input image (e.g., a tile of an input image as described in this specification) can include one or more incorrect or inaccurate pixel-wise values. This is because the computation of the system processing a tile of input can involve “neighbor pixels” so that a portion of the output pixels can be inaccurate.

The term “neighbor pixels” throughout the specification represents pixels surrounding a boundary of an input to the fully convolutional network model. The neighbor pixels can include pixels added to the boundary of the input through zero paddings specified by one or more layers of the fully convolutional network model. For fixed-size inputs (e.g., tiles extracted from a full input data) to the fully convolutional network model, the neighbor pixels can also include pixels originally surrounding the fixed-size inputs in the full input data.

The region that surrounds the input or fixed-size input to the fully convolutional network model and includes the neighbor pixels is referred to as “neighbor pixel region” throughout the specification. The neighbor pixel region can include a width of one or more pixels. In some implementations, the width of the neighbor pixel region can be determined based on the characteristics of the fully convolutional network model. The neighbor pixels can have or be replaced with zero pixel values during computations, rendering inaccurate the outputs from processing the neighbor pixels through the fully convolutional network model.

In some implementations, the neighbor pixels are initially in the full input data. When a fixed-size input is extracted from the full input data, the system might need one or more neighbor pixels to process the fixed-size input. However, the system might change the values of one or more non-zero neighbor pixels to be zero, rendering computations at some pixel locations inaccurate.

For example, the system can include one or more convolution layers having a filter size greater than one. To process boundary pixels of the fixed-size inputs, the system can compute corresponding pixel-wise outputs using one or more neighbor pixels outside the boundary pixels. The non-zero neighbor pixels might be replaced with zero values during the computation. By using the zero-value neighbor pixels—not the true pixel values associated with neighbor pixels—for processing the fixed-size input, the one or more pixel values in the fixed-size outputs can be inaccurate.

As another example, the system can include one or more transposed convolution layers with a filter size greater than one. The output pixel values can be inaccurate if the computation for one of the transposed convolution layers uses zero values to replace non-zero neighbor pixels.

In other words, the zero-value neighbor pixels (e.g., originally non-zero pixels replaced with zero values) can render the one or more pixel values in the output tiles inaccurate. Therefore, it is problematic for a system to perform operations in a fully convolutional network for processing fixed-size inputs to generate a final output by combining the fixed-size outputs without determining and discarding inaccurate data. The system needs to determine both accurate data (e.g., valid values) and inaccurate data (e.g., dummy pixel values) based on characteristics of network layers in the fully convolutional network when processing the fixed-size inputs.

The techniques described in this specification can determine which pixel-wise values in fixed-size outputs are inaccurate by analyzing characteristics of network layers in a fully convolutional network and determining layer or overall alignment information and suitable fixed sizes to compile the fully convolutional network model and tile input data. The alignment information and suitable fixed size can be used for a system adopting the described techniques to generate an accurate value for each pixel in the final output through the fully convolutional network model. The accurate value for each pixel is generated at least once in at least one fixed-size output and the system can obtain the accurate value for the pixel from at least one fixed-size output.

The techniques described in this specification can further reduce memory traffic by reducing and even avoid calculating invalid or overlapping pixel values between different fixed-size outputs. In some situations where a fixed size is determined, the techniques can optimize memory traffic between accelerators and the host by minimizing overlapping of accurate pixels of different fixed-size output tiles so that a valid final output can be generated based on the minimized overlapping. In some situations where the fixed size is not determined yet, the described techniques can select, as the fixed size, one of a plurality candidate fixed sizes based on the characteristics of the input data and hardware accelerators so that the calculations for generating inaccurate or overlapping pixel values are minimized or even eliminated.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example inference system for performing inference computations of a fully convolutional network for inputs with different sizes.

FIG. 2A illustrates an example inference process using a conventional system.

FIG. 2B illustrates an example inference process using the example inference system of FIG. 1.

FIG. 3A illustrates an example fixed-size input with neighbor pixel region and an example fixed-size output with dummy region.

FIG. 3B illustrates an example of tiling and stitching process performed by the example inference system of FIG. 1.

FIG. 3C illustrates another example of tiling and stitching process performed by the example inference system of FIG. 1.

FIG. 3D illustrates an example process of generating an output using a transposed convolution layer in an FCN model.

FIG. 4 illustrates an example process for performing inference computations of a fully convolutional network for inputs with different sizes.

### DETAILED DESCRIPTION

A fully convolutional network (FCN) can include at least one or more convolutional neural network layers, and optionally, pooling layers, transposed convolution layers, and element-wise layers (e.g., layers applying element-size activation functions). An FCN can be deployed on a hardware accelerator to generate pixel-wise predictions of an input (e.g., an input image with a plurality of pixels). In particular, an FCN is configured to generate an output with pixels associated with corresponding one or more pixels of the input image, and make predictions on each pixel of the input image. In some implementations, the FCN can also associate an output pixel with an input pixel and neighboring pixels in a fixed-size neighborhood. Because FCN models can process pixels of inputs, FCNs are in principle able to process inputs with arbitrary sizes.

While an FCN is advantageous compared to typical neural networks in that it can generate pixel-wise predictions for input data provided in different sizes, a few hardware limitations render it hard or even impossible to deploy an FCN on a hardware accelerator dynamically (i.e., process inputs with varying-size inputs).

Dynamically deploying an FCN to be capable of consecutively processing inputs of different sizes can raise issues in computational cost. First of all, network parameters including data structures (e.g., matrix dimensions for computations, or paddings, strides, filter sizes, and scale factors for network layers) scale with the size of the input and a change in the input size might require a shuffle of the current network parameters, which can lead to an increase of downtime (e.g., overhead) for a system including multiple hardware accelerators. Moreover, to allow for a dynamic input size, a host needs to send instructions for performing inference computations using more general execution mechanisms. For example, the host may allocate a larger memory for data storing (at the cost of being slower, and a portion of the large memory might not be used), perform more checks on vector or tensor sizes, or more frequently and dynamically change numbers of computing units used for performing calculations during parallel computation. Therefore, in practice, an FCN is usually statically deployed (e.g., compiled with fixed network hyper-parameters) on one or more hardware accelerators and configured to receive input of a fixed size, to avoid issues raised by dynamical deployment.

The techniques described below can solve the above-described problems by allowing a statically compiled FCN that has already been deployed (or to be deployed) on a hardware accelerator to effectively process inputs of different sizes.

The described techniques can tile input data with a particular size into a plurality of smaller inputs each having a fixed size. A statically compiled FCN on a hardware accelerator can process each of a plurality of fixed-size inputs and generate corresponding fixed-size outputs. The described techniques can accordingly stitch together the fixed-size outputs to generate a final output as if the input were entirely processed by an FCN compiled for the input size.

In general, the described techniques can provide a methodology to determine specific “tiling and stitching” parameters for tiling an input of a particular size into multiple fixed-size inputs, and stitching multiple fixed-size outputs generated from the multiple fixed-size inputs to generate a final output equivalent to an output generated by processing the input entirely by an FCN compiled for the particular size. More specifically, according to the characteristics of the FCN model, the described techniques can generate a fixed-size output having different regions by processing a fixed-size input tile through the FCN model. The different regions can include a dummy region and a valid region. The described techniques can, by analyzing the characteristics of the FCN model (e.g., paddings, strides, filter sizes, scale factors, and layer types for all layers in the FCN model), determine the valid region in the fixed-size output in which the pixel-wise values are accurate, i.e., no zero-value neighbor pixels are used to generate the output pixel values, and the dummy region in the fixed-size output in which the pixel-wise values are at least not “fully” accurate, i.e., the pixel-wise values are generated by the FCN by making use of at least one zero-value neighbor pixels. The described techniques can combine (e.g., “stitch”) accurate pixel-wise values from all of the fixed-size outputs to generate the final output, and ensure each accurate pixel-wise value corresponding to a pixel in the final output is generated and obtained from at least in one fixed-size output. This is in contrast to conventional parallelization techniques, where the input data are readily divided for independently generating output data and no consideration is needed for inaccuracy caused by neighbor pixels.

The described techniques can also determine a fixed size by various means prior to the FCN being compiled and deployed on a hardware accelerator. First, the described techniques can propose a plurality of candidate sizes based on characteristics of an FCN model and the hardware accelerator on which the FCN is deployed. The plurality of candidate sizes are valid and suitable for the tiling and stitching process performed by the described techniques. For example, if the FCN includes one or more transposed layer, the plurality of candidate sizes can be determined based on alignment information of output tiles. The term “alignment information” throughout the specification represents data representing constraints or requirements for the arrangement of fixed-size outputs. The alignment information is obtained by the system so that a fixed-size output can be properly projected to a fixed-size input, or vice versa.

The system can also determine coordinate shifts between a fixed-size output and a corresponding fixed-size input based on the alignment information to obtain a suitable tiling pattern. The tiling pattern can include one or more fixed-sizes (e.g., one or more candidate sizes to be selected automatically or by a user), overlapping sizes for fixed-size inputs at a particular fixed-size, and optionally, coordinates of fixed-size inputs and outputs, in particular, coordinates for dummy and valid regions of fixed-size outputs.

The determined tiling pattern must satisfy at least two criteria: (i) the alignment information should be correct, i.e., the tiling pattern should have fixed-size outputs correctly arranged so that each fixed-size output can be correctly projected back to a fixed-size input, or vice versa; and (ii) each pixel value for the full output data should be generated and extracted from at least a valid region of one fixed-size output. Optionally, the system can determine a tiling pattern that minimizes overlapping regions for the fixed-size inputs to improve computation performance and optimize computation resource usage. The details of determining a tiling pattern based on alignment information will be described below.

In some implementations, the described techniques can optionally select one of the candidate sizes included in a suitable tiling pattern as the fixed size based on performance metrics (e.g., total execution time or overhead). The described techniques can also generate a range of candidate sizes for deploying the FCN model on a hardware accelerator, and provide the range of candidate sizes for the user's selection. A user can pick one size out of the range of candidate sizes as the fixed size, according to characteristics of, for example, the FCN model, the hardware accelerator, or particular computation requirements according to tasks.

A tiling pattern as described above can include a fixed-size for tiling the full input data into one or more fixed-size inputs, and sizes of overlapping regions for generating the fixed-size inputs. In general, the system can tile the fixed-size inputs such that the fixed-size inputs often overlap each other to ensure obtaining accurate or correct pixel-wise values associated with all pixels in the final output, i.e., each accurate value is generated and obtained from at least one fixed-size output. A tiling pattern as described above can further include data representing a valid region and a dummy region for a fixed-size output. Fixed-size outputs can generally include a dummy region of a substantial size because of one or more zero-value neighbor pixels used for generating output pixel values. The system can adopt one or more algorithms to determine the alignment information based on the characteristics of the FCN model, and apply additional algorithms to determine a relation (e.g., a mapping) between coordinates of a fixed-size output and coordinates of a corresponding fixed-size input, determine valid regions for fixed-size outputs, and determine a coordinate shift for the fixed-size outputs based on the above-noted mapping and valid regions. The details of these algorithms will be described below.

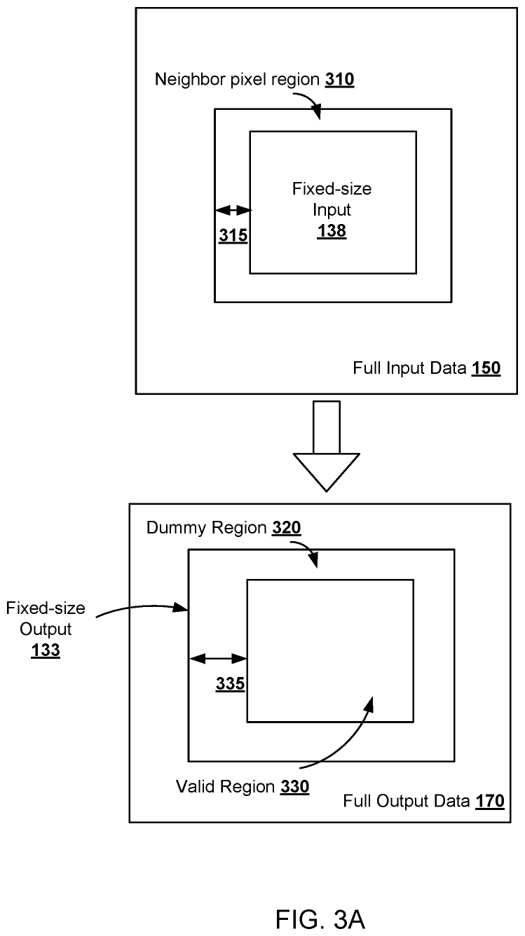

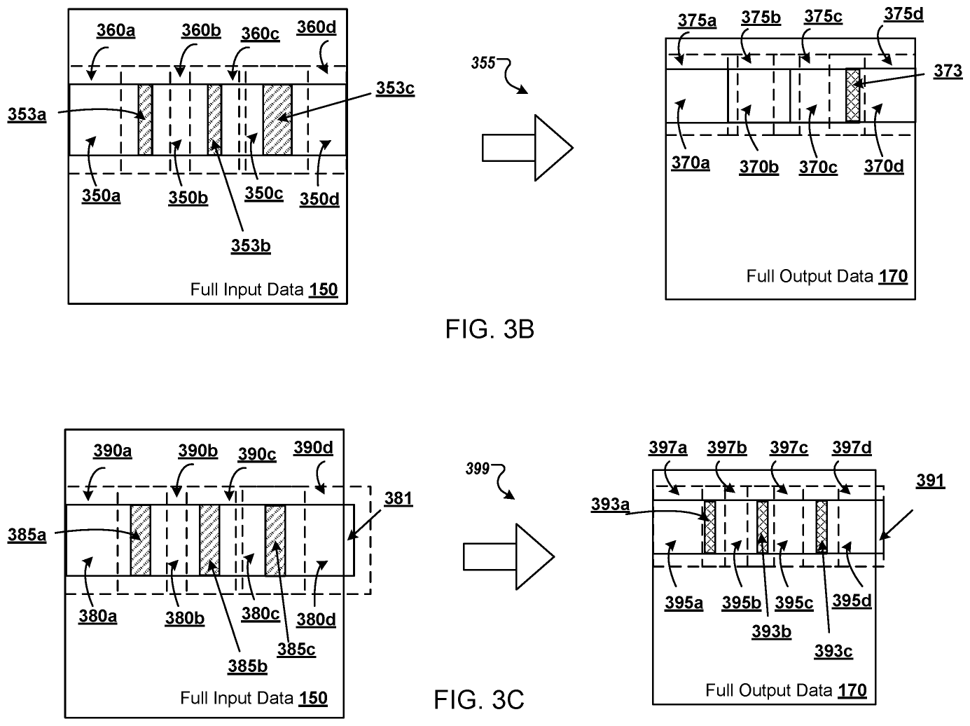

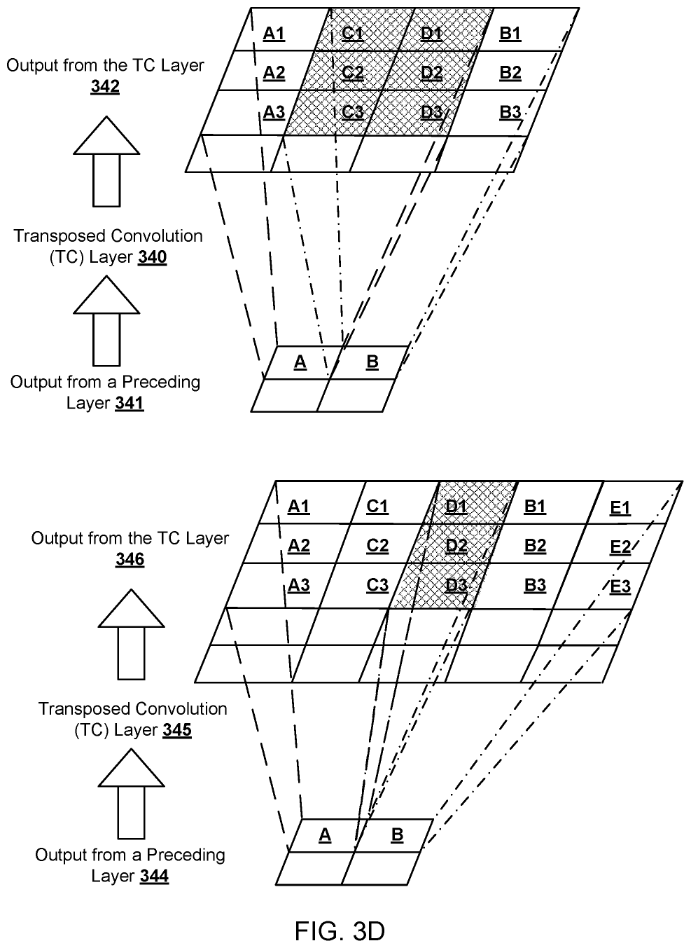

After determining the tiling pattern, the system can stitch together fixed-size outputs by combining valid regions of each fixed-size output. It is noted the tiling pattern is generated based on the alignment information for the FCN model. Since the system can generate a suitable tiling pattern for fixed-size inputs, the stitching process is quite efficient as the system has coordinate information for all pixels in the valid regions of the fixed-size output. In some implementations, the system can take pixel values in valid regions of the fixed-size outputs at least once for each pixel located in the full output data to generate the full output data. The details of stitching are described in connection with particular algorithms and FIGS. 3A-3D below.

Furthermore, the described techniques can perform “tiling and stitching” analysis both online and offline. For deploying a compiled FCN on a hardware accelerator in a manner similar to those previously deployed using the described techniques, a host processor can perform the analysis offline by re-using the previously saved parameters for “tiling” full input data and “stitching” output tiles to generate full output data with unknown or varying sizes. The previously saved parameters can include at least a tiling pattern such as alignment information for the FCN, a fixed-size for tiling, overlapping regions for the fixed-size inputs, or fixed-size outputs, or both, and dummy and valid regions of the fixed-size outputs. The system can re-use these parameters to process a new full input data and generate a full output data as if the new full input were directly processed by an FCN model compiled for the size of the new full input data. The host processor can generate a new set of “tiling and stitching” parameters for processing input data in situations where a new FCN is to be deployed.

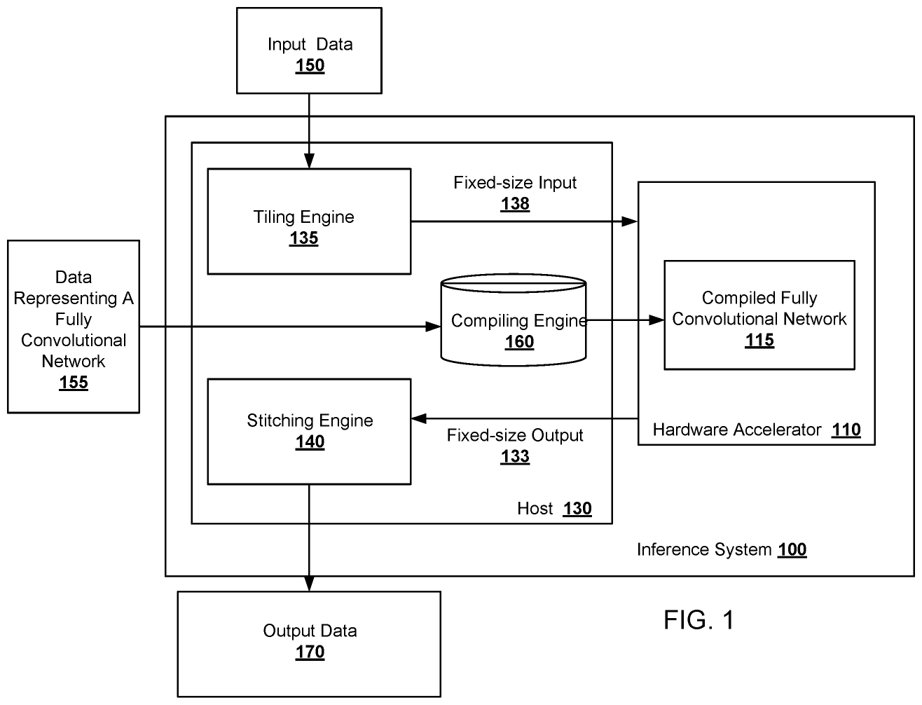

FIG. 1 shows an example inference system 100 for performing inference computations of a fully convolutional network for inputs with different sizes. The inference system 100 is an example of a system implemented as computer programs on one or more computers in one or more locations, in which the systems, components, and techniques described below can be implemented.

As shown in FIG. 1, the system 100 includes a host 130 and a hardware accelerator 110, communicating with each other. In general, the system 100 can receive input data 150 and generate output data 170 using a trained FCN 115 deployed on the hardware accelerator 110. In general, the output data 170 can have a size smaller than, larger than, or equal to the size of the input data 150.

More specifically, the system 100 can use the deployed FCN 115 for tasks such as object detection and classification (e.g., human face detection), image segmentation, image generation, image super-resolution, image completion, or image colorization, to name just a few examples. When the task is image segmentation, for example, the input data 150 can be an image input, the system 100 can generate output data 170 having pixel-wise predictions, i.e., a respective prediction for each pixel of the input image or for each pixel of an output image being generated by the FCN 115. The output data 170 can also include a respective score distribution for each pixel that assigns a respective score to each of a multiple categories. Given that, the system 100 can detect an existence, a shape, and a location of an object from an input image. When the task is image super-resolution, as another example, the system 100 can use the deployed FCN 115 to increase image resolution for an input image by predicting pixels to be added around each input pixel. Given that, the output image 170 can have a higher resolution than the input image 150, and one or more output pixels can be associated with each pixel in the input image.

The system 100 can compile, on a compiling engine 160 included in the host 130, an FCN for processing inputs with a fixed size and deploy the compiled FCN on the hardware accelerator 110. To compile the FCN, the host 130 can receive data 155 representing a trained FCN model on the compiling engine 160, compile the trained FCN model, and generate instructions (e.g., binary data) to deploy the trained FCN model on the hardware accelerator 110. In some implementations, the compiling engine 160 can re-compile the trained FCN model for processing different input data with varying sizes of input. The details of re-compiling a trained FCN model and deploying the re-compiled FCN model on the hardware accelerator 110 are described below.

In general, the compiled FCN 115 can process any suitable inputs having the same size (e.g., fixed-size inputs 138). The hardware accelerator 110 can therefore perform inference computations for the provided fixed-size inputs 138 using the compiled FCN model 115.

The compiling engine 160 can apply conventional compiling techniques for compiling an FCN on the hardware accelerator 110. In general, the compiling engine 160 can decode program codes written in any suitable high-order languages and encoded with data representing characteristics of the FCN, into machine-readable binary codes on a hardware accelerator. The data representing characteristics of the FCN can include hyper-parameters defining the structure of the FCN (e.g., input size, number of layers, number of nodes in each layer, layer types and positions, and padding, stride, filter size, and scale factor for one or more layers), and layer weights obtained from training process. During compiling, the system 100 needs to allocate respective computing resources based on the characteristics of the FCN. For example, the system 100 needs to allocate respective data structures to accommodate respective calculations for performing inference computations. As another example, the system needs to allocate respective memories for storing respective data structures and associated computation results during performing inference operations for the deployed FCN.

Conventionally, the system 100 needs to allocate respective data structures and memories according to the input size. For example, data structures allocated for layer weight matrices, activation inputs and outputs are at least based on the input size. The respective memories allocated for storing the data structure and associated computations results are also based on the input size. Therefore, the deployed FCN, once being deployed, is configured to receive inputs of a fixed size. Also, systems (e.g., the system 100) accordingly often compile FCN statically for receiving a fixed-size input so that the systems can allocate computation resources efficiently and once for all during compilation.

In some implementations, the host 130 can perform tiling-pattern analysis to determine tiling parameters, e.g., a suitable fixed size, for compiling the FCN 115 based on characteristics of the FCN model and the associated hardware accelerators. It should be noted that one or more hosts (e.g., offline analysis/compilation hosts) different from the host 130 can perform the tiling-pattern analysis offline or ahead of time off the host 130. Then the one or more hosts can compile and deploy the FCN 115 on the host 130 (e.g., one or more communicatively coupled computers), or deploy the FCN 115 as an “application” on one or more edge devices (e.g., cellphones or tablets) for processing inputs of random or unknown sizes. The details of determining the fixed size are described below.

The system 100 can include any suitable type of hardware accelerator 110 for performing inference computations of an FCN model. For example, the hardware accelerator 110 can be a CPU, GPU, or TPU. The hardware accelerator 110 can include components such as memory for storing parameters of the FCN model. Moreover, the hardware accelerator 110 can include one or more computing units for parallel computation.

The input data 150 can have one or more sizes different from the fixed size that the compiled FCN 115 is configured to process inputs of. For example, the input data 150 can include a plurality of image frames, each having a respective size different from the fixed size.

The generated output data 170 are outputs generated by the system 100 performing inference operations for a trained and statically-deployed FCN model 115 for the input data 150. The generated output data 170 can each have a respective size associated with the size of a corresponding input data.

As a simple example, if the input data (e.g., an input image) has a size of 500 by 500 pixels, the generated output 170 can have a size of 50 by 50 pixels, 500 by 500 pixels, or 1000 by 1000 pixels, with each pixel of the output data being associated with pixels within an 8 by 8, 10 by 10, or 20 by 20-pixel neighborhood of the input image based on the characteristics of the FCN model (e.g., the filter sizes, stride sizes, padding sizes, and scale factors for each layer of the FCN model). In general, the size of an output generated from an input by a trained FCN is a function of the characteristics of the FCN model.

For example and ease of illustration, a naive FCN model can include two network layers, each having a filter size of 2 by 2 pixels, a stride size of 1 pixel, and 1 by 1 zero paddings, so that each layer of the two layers can generate an output of 4 by 4 pixel by processing an input of 3 by 3 pixels. When a 3×3 input passes through both layers of the network, a 5×5 output is produced, and similarly a 5×5 input produces a 7×7 output through the naive FCN model.

Suppose the naive FCN model is compiled to receive a tile of 5 by 5 pixels tiled from the input data 150. The system can generate a fixed-size output of 7 by 7 pixels by analyzing the characteristics of the FCN model. The system can then determine a valid region and a dummy region for the fixed-size output and generate a final output 170 by associating pixel-wise values in the valid region with corresponding pixels in the final output for all fixed-size outputs. Referring to the above-noted example, the valid region of the fixed-size output generated by the naive FCN model can have a size of 3 by 3 pixels with pixel-wise values computed using the values in the 5 by 5-pixel input tile (i.e., the pixel-wise values in the valid region are not generated based on any padded zeros).

As another example, an FCN model can include two convolution layers, each layer having a filter size of 3 by 3 pixels, a stride size of 1, and no zero paddings. For a fixed-size input of 50 by 50 pixels, the fixed-size output generated by the FCN model processing the fixed-size input can have 46 by 46 pixels. The system 100 can determine there is no dummy region in the fixed-size output, and the valid region of the fixed-size output is 46 by 46 pixels.

As another example, an FCN model can include two convolution layers, each layer having a filter size of 3 by 3 pixels, a stride size of 1, and zero paddings of a single pixel. The fixed-size output by the FCN model processing a fixed-size input of 50 by 50 pixels can have a size of 50 by 50 pixels. The system 100 can determine a dummy region with a width of 2 pixels on all sides of the output data (e.g., an output image), and the valid region of the fixed-size output is 46 by 46 pixels. The process of determining the dummy and valid region of a fixed-size output is described in greater detail below in connection with the FirstValidPixelOffset( ) algorithm.

In general, if an FCN model includes one or more convolution layers that have a stride size greater than one, the input and output sizes can be a many-to-one mapping, no longer a one-to-one mapping. For example, an FCN model can include a first convolution layer, with a filter size of 3 by 3 pixels, a stride size of 1, and zero paddings of a single pixel, and include a second convolution layer, with a filter size of 5 by 5, a stride size of 2, and zero paddings of 1. The FCN model can generate an output the same size (e.g., 24 by 24 pixels) by processing inputs with different sizes (e.g., a 50 by 50 pixel input and a 49 by 49 pixel input). This is because the stride size 2 in the second convolution layer might trigger a rounding process when processing the input through each network layer.

In addition, an FCN model can include one or more transposed convolution layers. For example, the FCN model can include a transposed convolution layer with the filter size of 5 pixels, no zero padding, and a stride of 2 pixels. The transposed convolution layer can be appended to the second layer with a stride size of 2 pixels. A transposed convolution layer, in general, is configured to increase (e.g., blow up) the output size from an input provided by a preceding layer by a factor based on the stride size of the transpose convolution layer. In connection with the above example, the transposed convolution layer can produce an output of 51 by 51 pixels by processing the 24 by 24 pixel outputs from the second convolution layer. That is, the FCN model can process an input of 50 by 50 pixels or 49 by 49 pixels to generate a 51 by 51 pixel output.

The transposed convolution layer can generate or broaden a dummy region even though the padding size is zero. The size of dummy region can be based on characteristics of the transposed convolution layer, e.g., a relation between a filter size and a stride size. For example, if a transposed convolution layer has a stride size less than a filter size, the outputs can include dummy region because the calculation involves neighbor pixel region when a fixed-size input is extracted from a full input. As described above, by extracting a fixed-size input from a full input data, the FCN can involve one or more zero-value neighbor pixels instead of true pixel values into one or more computations, which renders the computations of boundary pixels in the fixed-size input inaccurate, and generates an output with a dummy region including inaccurate pixel values, and a valid region of true pixel values surrounded by the dummy region.

Referring back to the example above, the dummy regions are produced when a fixed-size input is extracted from a full input data (e.g., input data 150). Otherwise, they are not produced if the FCN is compiled for directly processing the full input data. For example, FCN models including one or more transposed convolution layers can generate an output with a dummy region. This is because when a fixed-size input is extracted from a full input data, which causes the pixel values of one or more non-zero neighbor pixels that contribute to an output to be replaced with zero values.

To determine the valid region and the dummy region of a fixed-size output, the system 100 can trace one or more pixels in the input image for an output pixel, or vice versa, by analyzing the characteristics of an FCN model and the coordinates of the output pixel. For example, the system 100 can locate 50 by 50 pixels in an input tile for generating a fixed-size output of 51 by 51 pixels. As described above, tiles generated from the input data 150, by the host 130 or the hardware accelerators 110 having suitable computation powers, can overlap one and another on one or more pixels, so the system can adopt particular algorithms (e.g., the ProjectBackwards( ) algorithm as described in greater detail below) to trace back corresponding input pixels used for generating output pixels in the fixed-size output through the deployed FCN model.

Referring back to FIG. 1, the host 130 can communicate with the hardware accelerator 110 by transferring data, or instructions, or both. The host 130 and the hardware accelerator 110 can communicate through wired or wireless connections and, in some cases, can be located remotely from each other. For example, the host 130 can be a server at a different physical location from where the accelerator 110 is located.

The host 130 can receive the input data 150 of sizes greater than the fixed size, and generate a plurality of fixed-size inputs 138, each having a smaller size than the input data 150. The host 130 can provide the fixed-size inputs 138 to the hardware accelerator 110 and receive a plurality of corresponding fixed-size outputs 133 from the hardware accelerator 110. The received fixed-size outputs 133 are generated by the hardware accelerator 110 performing inference operations of the deployed FCN 115 for the provided plurality of fixed-size inputs 138.

In some implementations, as described above, hardware accelerators including hardware components such as CPUs can perform the tiling process to tile the input data 150 into multiple fixed-size inputs 138.

In situations where the input data 150 have a smaller size than the fixed size, the system 100 can pad zeros around the input data 150 to reach the fixed size, and provide it to the hardware accelerator 110 for performing inference computations.

To generate the output data 170, the host 130 can further include a stitching engine 140 configured to combine the received fixed-size output 133. The stitching engine 140 can perform the stitching process by determining alignment information for each of the fixed-size outputs 133 based on the fixed size and characteristics of the deployed the FCN model, and generate a final output 170, which is an equivalent output obtained as if by directly processing the input data 150 without tiling and using the same FCN model but deployed for processing inputs with the size of the input data 150.

In some implementations, hardware accelerators including hardware components capable of performing the stitching process can generate the final output 170 on the hardware accelerators based on the fixed-size outputs 133, and provide the final output 170 to the host 130 or on a display of a user interface.

In some implementations, the tiling and stitching process throughout this specification do not have to be performed off a host. For example, any suitable accelerators including suitable hardware components such as CPUs can perform the tiling and stitching process on the accelerators. Moreover, the tiling and stitching process can be performed at different physical locations from the host. For example, the tiling can be performed by a first set of accelerators at a first place, the stitching process can be perform by a second set of accelerators at a second place, and the host can be located at a third place and configured to receive a final output from the second set of accelerators. The accelerators and hosts are communicatively connected, either physically or wireless connected at one or more locations.

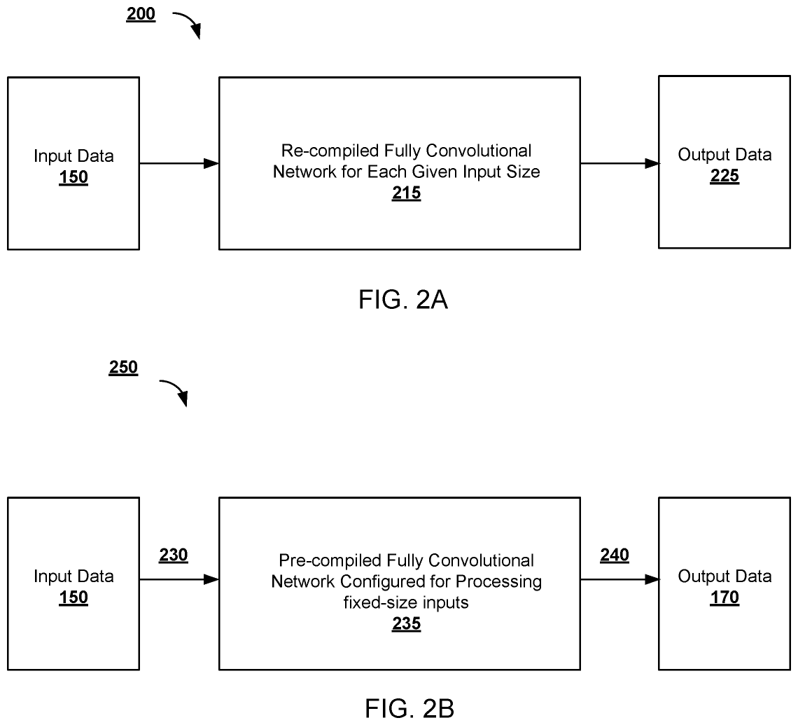

FIG. 2A illustrates an example inference process 200 using a conventional system.

As shown in FIG. 2A, a conventional inference system 200 can receive input data 150 (as shown in FIG. 1), and generate output data 225 by performing inference computations for a deployed FCN 215 processing the input data 150. The output data 225 can be substantially similar to the output data 170 as shown in FIG. 1. The input data 150 can be input images as described above.

Each of the input data 150 can have a different size, so that the conventional system needs to re-compile the FCN 215 for the hardware accelerator for processing different input sizes. For example, if the first input data has a size of 50 by 50 pixels, the system can deploy the FCN 215 on the hardware accelerator to be configured to process inputs of the size 50 by 50 pixels. However, if the second input data has a different size from the first input data, for example, 100 by 100 pixels, the system has to re-compile the FCN 215 to be configured to process inputs of the size 100 by 100 sizes.

For input data with different sizes, the conventional system needs to first determine the size of a particular input, and then determine if it is needed to re-compile the FCN 215 for processing the particular input. Additionally, the system 200 needs to perform extra computational checks to monitor if memory and data structures are properly allocated. Given that, the conventional techniques for performing inference computations can cause a substantial amount of overhead, decreasing the computation efficiency for generating inference outputs given varying-size inputs.

FIG. 2B illustrates an example inference process 250 using the example inference system 100 of FIG. 1.

As shown in FIG. 2B and in connection with FIG. 1, the inference system 100 adopting the described techniques can avoid re-compiling a deployed FCN for inputs with different sizes, which decreases overhead and improves computation efficiency. More specifically, the system 100 first statically deploys an FCN model 235 on a hardware accelerator. The system 100 can determine alignment information based on the characteristics of the FCN model, and determine a tiling pattern including a fixed-size for tiling, dummy regions and valid regions of fixed-size outputs so that each valid pixel can be obtained from at least one fixed-size output. The FCN model 235 is compiled for processing inputs with the fixed size. The system 100 can tile the input data 150 to generate a plurality of fixed-size inputs 230 based on the tiling pattern, and provide the fixed-size inputs 230 for performing inference computations using the deployed FCN 235. The system 100 can obtain fixed-size outputs 240 from the deployed FCN 235, and stitch together the fixed-size outputs 240 for generating a final output data 170. The output data 170 is equivalent to output data 225, which is obtained by directly processing the full input data 150 using an FCN 215 compiled for processing the full input data 150. The details of tiling and stitching are described below.

In some implementations, the system 100 can determine a set of candidate sizes that are suitable for the FCN model to process a random-size input. The system can 100 determine the set of candidate sizes from all tile sizes based on the characteristics of the FCN model (e.g., layer properties such as a filter-size, a stride side, etc.). It should be noted that some tile sizes cannot be used according to the characteristics. For example, a particular input size cannot generate an output size based on the filter sizes and stride sizes of the FCN model. For example, the system 100 can remove sizes from all possible sizes that are not suitable for the FCN model to generate the candidate sizes.

In some implementations, the system 100 can select a fixed size from a plurality of candidate sizes for deploying an FCN model. For example, the system 100 can select the fixed size based on performance.

In some implementations, for each of the candidate sizes, the system 100 can deploy a respective copy of the FCN model on a respective hardware accelerator for processing inputs having one of the candidate sizes. The system 100 can measure a level of performance, for example, a total execution time for performing inference computations using different copies of the FCN network processing different fixed-size inputs, or, as another example, overhead in the system 100 including multiple hardware accelerators for performing inference computations for a respectively deployed FCN. Based on the performance measurement, the system 100 can select one of the candidate sizes as the fixed size for deploying the FCN model on a particular hardware accelerator. For example, the system 100 can select the candidate size that leads to the minimum total execution time. As another example, the system 100 can select the candidate size that causes the least overhead. Optionally, the system 100 can select the candidate size having satisfactory execution time and overhead for performing inference computations.

The selection of candidate size can be based upon the characteristics of the trained FCN model. For example, suppose a candidate size for tiling (or for the deployed FCN model) is too small, the fixed-size outputs generated from the fixed-size inputs of the candidate size can also be small and even do not include any valid regions (i.e., all the pixel-wise values in the fixed-size outputs are in the dummy region.)

Optionally, the system 100 can provide a discrete range of candidate sizes to a user for selecting one candidate size within the range as the fixed size. The discrete range of candidate sizes can be non-consecutive based on characteristics of the FCN (e.g., the number and positions of one or more transposed layers, and characteristics of each layer included in the FCN). For example, the range of candidate sizes can be even pixels from 10 by 10 pixels to 30 by 30 pixels. A user can choose 16 by 16 pixels as the fixed size within the provided range.

Moreover, the fixed size does not have to be a scalar. Instead, the fixed size can be a vector representing a rectangle in two-dimensional space, or a block in three-dimensional space. More specifically, the fixed size can include a respective value in a respective dimension. For example, if the input image is two-dimensional, the system 100 can determine a fixed size vector with a first size for the first dimension (e.g., horizontal dimension) and a second size for a second dimension (e.g., vertical dimension) different from the first dimension. The system 100 can generate a plurality of fixed-size inputs of 30 by 10 pixels from an input image with a size of 300 by 100 pixels.

Referring to FIGS. 1 and 2B, after receiving input data 150, the system 100 can determine a plurality of fixed-size inputs from the received input data. For an input data having a size larger than the fixed size, the system 100 can analyze the input data and tile the input data into a plurality of fixed-size inputs, with or without any overlapping. For an input data having a size smaller than the fixed size, the system 100 can pad zeros around the input data to reach the fixed size, and provide the padded input (now also of the fixed-size) to the deployed FCN model for performing inference computations.

To tile the received input data 150 into a plurality of fixed-size inputs 138, the host 130 can include a tiling engine 135 configured to receive the input data 150, and generate the plurality of fixed-size input 138 based on a tiling pattern. Alternatively, suitable hardware accelerators 110 can tile the input 150 into multiple tiles of the fixed size. More specifically, the host 130 can send instructions to a hardware accelerator 110 including binary data representing a compiled FCN model and memory addresses storing the input data 150. The hardware accelerator 110 can include suitable computation components such as CPUs and is configured to obtain one or more tiles by accessing (e.g., direct memory access) corresponding memory addresses that store pixel-wise values for the one or more tiles. For example, the hardware accelerator can obtain a tile of 5 by 5 pixels by accessing the corresponding memory addresses storing the pixel-wise values of the tile, without accessing memory addresses storing pixel-values outside the tile. In this way, the system 100 can reduce memory traffic and improve the computation efficiency, as described above.

The system 100 can determine a tiling pattern for tiling the input data 150 into a plurality of fixed-size inputs 138. For example, the tiling engine 135 can tile the input data 150 into fixed-size inputs at a particular size with a particular overlapping size, for example, the tiled fixed-size inputs do not have any overlapping, or each has a shared overlapping region of a particular size, or each overlaps with each other at a respective size. The total number of fixed-size inputs generated from an input data accordingly depends on the tiling pattern.

It is noted that a tiling pattern is determined further based on alignment information if the FCN model includes one or more transposed convolution layers with stride sizes greater than one.

The overlapping size for the tiling pattern can be any proper size smaller than the fixed size. For example, each fixed-size input can have a shared overlapping size at a width of one pixel and a length of an edge of the fixed-size input. As another example, the overlapping size can be at a width of two pixels, three pixels, and five pixels. The fixed size and overlapping size for tiling are determined at least based on the alignment information.

The system 100 can determine a tiling pattern automatically based on the characteristics of an FCN model or user instructions. For example, the system 100 can tile an input image of 100 by 100 pixels into four fixed-size inputs, each of 60 by 60 pixels. Each of the fixed-size inputs can have an overlapping region 20 by 60 pixels, 60 by 20 pixels, or 20 by 20 pixels with one another.

Optionally, the system 100 can also generate a tiling pattern such that the fixed-size inputs have respective overlapping regions with one another. For example, the input image of 70 by 30 pixels can be tiled into fixed-size inputs with 30 by 30 pixels, compatible with the deployed FCN model. In one situation, the four fixed-size inputs overlap each other in a region of 20 by 30 pixels. It is noted the last fixed-size input can have a region of 10 by 30 pixels outside the input image, and this region can be extended or padded with zeros. In some implementations, the system can shift the overlapping region of the last fixed-size input with other inputs to reduce and even eliminate padded zeros to improve computation efficiency.

In some implementations, the system 100 can determine a tiling pattern based on suitable machine learning models trained on various training data. The training data can be respective sets of fixed-size inputs for the same copies of input but each tiled based on different tiling patterns. The machine learning models can output one or more tiling patterns for the system 100 or for the user to select for the system 100.

The system 100 can generate an output 170 by stitching the fixed-size outputs using a stitching engine 140. Since the system 100 has obtained the tiling pattern including coordinates of pixels in the valid regions, the system can efficiently stitch pixels from valid regions to generate a full output data. The system can adopt an algorithm for the stitching process, which will be described in more details below.

The system 100 can, for each fixed-size output, obtain coordinates of the particular fixed-size output, and coordinates of a corresponding fixed-size input for generating the particular fixed-size output. The coordinates of a particular fixed-size input represent the position of the fixed-size input with respect to the original input 150, and similarly, the coordinates of a particular fixed-size output represent the position of the fixed-size output with respect to the corresponding final output 170. The system 100 can determine a respective coordinate frame (e.g., Cartesian coordinate frame, or any proper discrete coordinate frames), and an origin of the coordinate frame for each input and corresponding output data. The system 100 can determine coordinates of fixed-size inputs during the tiling process, and determine coordinates of corresponding fixed-size outputs according to the characteristics of the deployed FCN model 115. Likewise, the system 100 can first determine coordinates of fixed-size outputs, and then determine coordinates of corresponding fixed-size inputs based on the characteristics of the FCN model 115. The system 100 can apply one or more algorithms to generate alignment information, generate a relation between the coordinates of a fixed-size input and a fixed-size output, and stitch fixed-size outputs based on the relation. The details of alignment information are described below.

Once the alignment constraints for the FCN model is satisfied, the system 100 can further determine a central valid region and a peripheral dummy region of each fixed-size output after associating coordinates of the fixed-size outputs and corresponding fixed-size inputs. The central valid region includes pixels generated using valid pixels from the corresponding fixed-size input. The dummy region includes pixels generated using one or more zero-value neighbor pixels (e.g., from zero values that should have been non-zero for the pixels of the full input image outside the fixed-size input).

The system 100 can determine one or more overlapping regions between the fixed-size outputs. Optionally, the system can also determine if at least a portion of the overlapping regions belong to a valid region of the fixed-size outputs. In some implementations, the system 100 can determine a coordinate shift for one or more overlapping fixed-sized outputs, so that valid regions of different fixed-size outputs are positioned abutting or adjoining with each other without overlapping.

FIG. 3A illustrates an example fixed-size input 138 with neighbor pixel region 310 and an example fixed-size output 133 with dummy region 320.

As described above, the system 100 can tile the full input data 150 into a plurality of fixed-size inputs with a fixed size compatible for the deployed FCN model. The system 150 can determine tiling patterns for the input data 150, and generate fixed-size inputs by tiling the input data 150 from top to bottom, left to right. The tiling patterns can include overlapping regions, and inherently positions defined by respective coordinates of each fixed-size input. For example, as shown in FIG. 3, one fixed-size input 138 is located in a particular position of the full input data 150. The details of tiling patterns are described in connection with FIGS. 3B and 3C below.

The position of the fixed-size input 138 can be represented using coordinates of one or more corner pixels with respect to an origin of the full input data 150. For example, the system can determine the top-left corner pixel of the full input data 150 as the origin (0, 0). The coordinates for each fixed-size input are determined with respect to the origin. For example, the system 100 can use coordinates of the top left corner pixel and the bottom right corner pixel of the fixed-size input 138 to represent the position and size of the input 138.

The fixed-size inputs can be represented by any suitable coordinate frames. For example, the coordinates of each fixed-size input 138 can be represented in a Cartesian coordinate frame, a cylindrical coordinate frame, or any other suitable coordinate frames.

The tilling pattern can define a position for each fixed-size input 138 in any suitable manner. For example, the fixed-size inputs can be positioned in rows and columns. As another example, the fixed-size inputs can be scattered and mismatched. In other words, the fixed-size inputs 138 do not have to line up with each other in rows and columns, e.g., a zig-zag pattern.

The system 100 can annotate a position of a fixed-size input with any suitable notations. For example, the system 100 can use (i,j) notations to represent a fixed-size input in the i^{th} position along a first dimension and j^{th} location along a second dimension. For simplicity and in the following specification, the system 100 annotates the fixed-size inputs in a tiling grid. That is, each fixed-size input is denoted with a sequence number along a row and a column. Each fixed-size input can be considered in a substantially rectangular shape. However, it should be appreciated that the tiling pattern and annotations can vary based on the tiling requirements.

The system 100 can denote the coordinates of the top left corner pixel as (htᵢ^{I}, wtⱼ^{I}), and the bottom right corner pixel as (hbᵢ^{I}, wbⱼ^{I}), where i and j stand for the numbering of each fixed-size input with respect to the input data 150, For example, i and j stand for a respective row and column for a fixed-size input of all the multiple fixed-size inputs.

As another example, assuming the input image has 100 by 100 pixels, and the system 100 tiles the input image into a 3 by 3 grid (i.e., 9 fixed-size inputs) with respective overlapping sizes. Fixed-size inputs of the first row of the 3 by 3 grid can include a first fixed-size input located at the first grid can have coordinates of (ht₁^{I}, wt₁^{I})=(0,0) and (hb₁^{I}, wb₁^{I})=(50,50); a second fixed-size input located at the second grid can have coordinates of (ht₁^{I}, wt₂^{I})=(0,40) and (hb₁^{I}, wb₂^{I})=(50, 90); and a third fixed-size input located at the third grid can have coordinates of (ht₁^{I}, wt₃^{I})=(0,80) and (hb₁^{I}, wb₃^{I})=(50, 130). Fixed-size inputs of the first column of the 3 by 3 grid can include the first fixed-size input, a fourth fixed-size input located at the fourth grid can have coordinates of (ht₂^{I}, wt₁^{I})=(40,0) and (hb₂^{I}, wb₁^{I})=(90, 50), and a fifth fixed-size input located at the seventh grid can have coordinates of (ht₃^{I}, wt₁^{I})=(80,0) and (hb₃^{I}, wb₁^{I})=(130, 50). It is noted that the pixel values of the third and fifth fixed-size inputs outside the input image can be extended and set as zeros.

To avoid redundantly counting or calculating edge pixels of each of the multiple fixed-size inputs 138, in some implementations, during tiling, the system 100 can determine for each of the fixed-size inputs 138, pixels on the top and left edges of a fixed-size input are considered as included in the fixed-size input, while pixels on the bottom and right edges of the fixed-size input are not considered as included in the fixed-size input.

Before tiling the input data 150 into a plurality of fixed-size inputs, the system 100 can determine whether the input data is smaller than the fixed size set for the system 100. In response to determining the input data 150 is smaller than the fixed size, the system 100 can pad zeros around the periphery of the input data 150 to reach the fixed size.

It is noted that the term “neighbor pixel region 310,” as described above, represents a region including neighbor pixels generated by using zero values to replace original non-zero values for the neighbor pixels. For example, the neighbor pixel region 310 can include a region, as shown in FIG. 3A, including one or more neighbor pixels of the fixed-size input 138 in the full input data 150. The width 315 of the neighbor pixel region 310 can represent a number of neighbor pixels included in the neighbor pixel region 310. The system 100 can determine the width 315 for the neighbor pixel region 310 based on the characteristics of the deployed FCN 115 model.

The system 100 can obtain coordinates for each fixed-size output 133 with respective to the final output data 170. For example, the system 100 can select the top left corner pixel of the final output data 170 as the origin, and denote the coordinates of the top left corner pixel of the fixed-size output as (htᵢ^{O}, wtⱼ^{O}), and the bottom right corner pixel as (hbᵢ^{O}, wbⱼ^{O}), where i and j stand for the numbering of each fixed-size output with respect to the output data 170. For example, i and j stand for a respective row and column for a respective fixed-size output of all the fixed-size outputs.

The system can, as described above, further determine a valid region 330 and a dummy region 320 for each fixed-size output 133 based on the characteristics of the FCN model. In general, the valid region 330 can be located at the center of the fixed-size output 133 and the dummy region 320 can surround the periphery of the valid region 330 at a width 335. The width 335 determines a particular number of pixels in each dimension of the dummy region 320. The valid region includes pixel-wise values for pixels in the valid region that are computed using the valid pixel-wise values in the corresponding fixed-size input 138, and the dummy region 320 includes pixel-wise values for pixels in the dummy region that are computed using at least one or more neighbor pixels during the tiling process or through the operations characterized in one or more layers in the FCN model. The pixel-wise values for the pixels in the valid region 330 contribute at least a portion to the final output 170, while the dummy pixels will be eliminated or discarded during the stitching process.

The system 100 can determine the valid region 330 and dummy region 320 by tracing back from a pixel in the fixed-size output through the FCN model to one or more pixels in the corresponding fixed-size input, according to the characteristics of the FCN model. More specifically, the system 100 can perform the FirstValidPixelOffset( ) algorithm as described below to determine a width for a dummy region, and the valid region is the rest of the region in the output.

More specifically, the FirstValidPixelOffset( ) algorithm is configured to propagate invalid information layer by layer to determine a final dummy region of the FCN output. On the first layer of the FCN, the layer produces a dummy region on its output due to the use of pixels in the neighbor pixel region for the first layer. However, from the second layer onwards, the dummy region of the layer output grows due to the use of neighbor pixels and dummy pixel values produced and propagated from the preceding layer.

By performing the FirstValidPixelOffset( ) algorithm, the system 100 can determine the width 335, and inherently the number of pixels within the width 335 based on the characteristics of the FCN model (e.g., respective filter sizes, zero padding sizes, stride sizes, and scale factors for all layers in the FCN model). It is noted that the width 335 of the dummy region can include all dummy pixels. However, in some implementations, the width 335 is large enough to include all dummy pixels and one or more valid pixels.

If the FCN model includes one or more transposed layers, the system 100 can determine the width 335 of the dummy region 320 based on the number and positions of the one or more transposed layers. In connection with FIG. 3D, which illustrates an example process of generating an output using a transposed convolution layer 340, 345 in an FCN model, the FCN model can be an equivalent to the compiled fully convolution network 115 of FIG. 1. For simplicity, a system being properly configured, e.g., the inference system 100 of FIG. 1, can perform the process of FIG. 3D.

As shown in FIG. 3D, an FCN model can include a transposed convolution layer 340 configured to receive an output 341 of 2 by 2 pixels from a preceding layer in the FCN model. The system can perform operations associated with the transposed convolution layer 340 to generate an output 342 of 4 by 4 pixels. The transposed convolution layer 340 includes a filter size of 3 by 3 pixels with a stride size 1. The transposed convolution layer 340 does not include any zero paddings. The input pixel A is associated with output pixels A1, A2, A3, C1, C2, C3, D1, D2, and D3, and the input pixel B is associated with output pixels C1, C2, C3, D1, D2, D3, B1, B2, and B3. The overlapping region of the output pixels associated with input pixels A and B includes pixels C1, C2, C3, D1, D2, and D3.

It is noted that pixels C1, C2, and C3 are also associated with an input pixel on the left of the pixel A in the output 341 (not shown). Similarly, pixels A1, A2, and A3 are associated with two input pixels on the left of the pixel A, and pixels D1, D2, and D3 are associated with input pixels A and B and another input pixel on the right of the pixel B.

Assuming the full input image can generate an intermediate output through the preceding layer including the first pixel on the left of the pixel A, the pixel A, and the pixel B, the pixel values of A1, A2, A3, C1, C2, and C3 are not accurate because the fixed-size input does not generate pixel values for the first pixel, thus the system 100 uses zero-value neighbor pixels to represent the first pixel to generate a partial output for pixels A1, A2, A3, C1, C2, and C3. However, the pixel values of D1, D2, D3, B1, B2, and B3 are accurate because both full input and fixed-size input use zero pixel values for pixels on the right of pixel B.

Similarly, the transposed convolution layer 345 includes a stride size of 2 pixels in both directions and a filter size of 3 by 3 pixels, and is configured to receive an output 344 from a preceding layer, and generate an output 345 of 5 by 5 pixels. The input pixel A is associated with pixels A1, A2, A3, C1, C2, C3, D1, D2, and D3, and the input pixel B is associated with pixels D1, D2, D3, B1, B2, B3, E1, E2, and E3. The overlapping regions include pixels D1, D2, and D3, which are accurate because these pixels are not calculated using neighbor pixels.

While FIG. 3D only represents determining accurate and inaccurate pixel values for a sole transposed convolution layer, the system 100 can determine the dummy region and valid region for fixed-size outputs by analyzing the relation between input and output for all layers of the FCN model as described above.

In addition, the system 100 can determine alignment information based on the relation between the input and output for each layer of the FCN model.

For example and as shown in FIG. 3D, different from the transposed convolution layer 340, the transposed convolution layer 345 has a stride of 2 pixels. Therefore, an output including C1, C2, C3, D1, D2, D3, B1, B2, and B3 does not have a corresponding pixel in the output 344. The system 100 can determine alignment information for the transposed convolution layer 345 to be an integral multiple of 2 pixels. The integral multiple of 2 pixels can be, e.g., 2, 4, 8, and 10 pixels, which is included in the alignment information for guaranteeing a valid mapping at the transposed convolution layer.

If the FCN model includes two or more transposed layers, the system 100 can determine overall alignment information (e.g., accumulated alignment values for all layers, or the overall alignment values) for the entire FCN model based on the characteristics of all transposed layers (e.g., a number, positions, and strides of transposed layers). In some implementations, the system 100 can determine the overall alignment information as the product of respective stride sizes of all transposed layers.

The system 100 can determine the alignment information from multiple candidate alignment values based on the correctness of the final output, memory traffic during computation, and the computation efficiency. In particular, regarding the correctness of the final output, the system 100 can choose the overall alignment values that guarantee each pixel of the final output can be obtained from a valid region of one of the fixed-size outputs.

For FCN models including other types of layers such as pooling layers, the system 100 can treat the other types of layers as a form of convolution layer for analyzing the tiling and stitching process. For example, a max-pooling 2 by 2 layer can be treated as a convolutional layer having a stride of 2 pixels, a filter size of 2 by 2 pixels, and no zero paddings for analyzing the tiling and stitching process.

It is noted that for ease of illustration, while the size of outputs 341 and 344 is 2 by 2 pixels, the size of output 342 is 4 by 4 pixels, and the size of output 346 is 5 by 5 pixels, the input and output can generally have any suitable sizes. Similarly, the filter size, stride, and zero paddings for the transposed convolution layers 340 and 341 can include any suitable sizes.

In general, if the FCN model includes one or more transposed layers, the determination of a dummy region in a fixed-size output can become substantially complex. However, the system performing techniques described in this specification can determine a propagation of dummy regions from a preceding layer to a succeeding layer no matter whether a layer is a convolution layer or a transposed convolution layer, and determine the dummy region for the fixed-size output given a fixed-size input based on the characteristics of the FCN model, theoretically, no matter how many network layers the FCN model includes.

One or more layers of an FCN model can have different properties along different dimensions (e.g., a height and width dimension for a two-dimension layer). For example, the filter size, stride size, or padding size of a network layer may not be the same along the height and width dimensions (e.g., a filter size of 3 by 2 pixels, a stride size of 2 by 1 pixels, and a zero padding size of 0 by 1 pixels). The described techniques in this specification can calculate alignment information, dummy regions, and tiling patterns independently along each dimension, which might produce non-uniform fixed-size outputs along the different dimensions. For example, the system 100 can generate a non-uniform width for the dummy region 320, i.e., the width 335 can be non-uniform for the dummy region 320. For example, the width 335 of the left and right portions of the dummy region 320 can be greater than the top and bottom portions.

Generally, an FCN model can receive input tensors and generate output tensors in multiple dimensions. For example, an input tensor can have multiple channels C and multiple batches B, in addition to the height H and the width W dimensions as described above.

The FCN model can be adapted to process each of the multiple dimensions of an input as long as the dimension is fully convolutional. For example, an FCN model can process an image input with B×H×W×C dimensions. Assuming that the batch dimension and channel dimension are not fully convolutional, the FCN model can process the input only in the height and width dimensions, where the process can be generally considered a two-dimension problem. As another example, an FCN model can process an audio input with multiple dimensions by processing only a single dimension of the audio input if the rest of the dimensions are not fully convolutional. Alternatively, the FCN model can process higher dimensions, e.g., higher than two dimensions, if these dimensions are fully convolutional.

The system 100 can also determine the coordinates of the valid region 330 of the fixed-size output 133. Similarly, the system can denote the top left corner pixel of the valid region as (htᵢ^{V}, wtⱼ^{V}), and the bottom right corner pixel as (hbᵢ^{V}, wbⱼ^{V}), with respect to the origin of the fixed-size output 133. For example, i and j stand for a respective row and column for the corresponding fixed-size output 133, or the valid region of the corresponding fixed-size output 133.

For a deployed FCN model without transposed convolution layer, the system 100 can stitch the fixed-size outputs through the first algorithm described below. As another example, for a deployed FCN model with transposed convolution layer, the system 100 can stitch the fixed-size outputs based on alignment information generated using the second algorithm described below.

The first algorithm can guarantee that valid regions of fixed-size outputs do not overlap, and the second algorithm would potentially cause valid regions of fixed-size outputs to overlap, which requires extra steps to correctly combine the fixed-size outputs. The extra steps can include coordinate shifts for each valid region of fixed-size outputs, or each of the fixed-size outputs, or both, and the details of the coordinate shift are described below.

When using the first algorithm, the system 100 can denote the width of dummy regions 335 as b, and mapping functions I(i,j)=(htᵢ^{I}, wtⱼ^{I}, hbᵢ^{I}, wbⱼ^{I}), O(i,j)=(htᵢ^{O}, wtⱼ^{O}, hbᵢ^{O}, wbⱼ^{O}), and V(i,j)=(htᵢ^{V}, wtⱼ^{V}, hbᵢ^{V}, wbⱼ^{V}) for coordinates of a fixed-size input, a corresponding fixed-size output, and a valid region of the fixed-size output, respectively. Each mapping function can return a particular coordinate in a particular direction (e.g., I(i,j)·ht=htᵢ^{I} represents a coordinate in a vertical or height direction). For simplicity, the system 100 assumes the fixed-size inputs and fixed-size outputs are squares in two-dimensional space, and denotes the size of the fixed-size inputs as T_{I}, and the fixed-size outputs as T_{O}. The system 100 denotes the size for the initial input data as H_{I} and W_{I}, and without losing generality, it is assumed that H_{I}>=T_{I} and W_{I}>=T_{I}. It is also noted the fixed-size inputs and outputs can be rectangular in some implementations.

The system 100 can execute the first algorithm below, using dynamic programing to scan from left to right and top to bottom, according to respective coordinates of the fixed-size outputs, for generating the final output 170. The first algorithm reads as follow:

$$\begin{matrix}Initialize : \\ O ( 0 , 0 ) = ( 0 , 0 , {T}_{O} , {T}_{O} ) \\ V ( 0 , 0 ) = ( 0 , 0 , {T}_{O} - b , {T}_{O} - b )\end{matrix}$$

$$\begin{matrix}Left boundary tiles : \\ O ( i , 0 ) = ( V ( i - 1 , 0 ) \cdot hb - b , 0 , V ( i - 1 , 0 ) \cdot hb - b + {T}_{O} , {T}_{O} ) \\ V ( i , 0 ) = ( V ( i - 1 , 0 ) \cdot hb , 0 , V ( i - 1 , 0 ) \cdot hb - 2 b + {T}_{O} , {T}_{O} - b )\end{matrix}$$

$$\begin{matrix}Top boundary tiles : \\ O ( 0 , j ) = ( 0 , V ( 0 , j - 1 ) \cdot wb - b , {T}_{O} , V ( 0 , j - 1 ) \cdot wb - b + {T}_{O} ) \\ V ( 0 , j ) = ( 0 , V ( 0 , j - 1 ) \cdot wb , {T}_{O} - b , V ( 0 , j - 1 ) \cdot wb - 2 b + {T}_{O} )\end{matrix}$$

$$\begin{matrix}Internal tiles : \\ O ( i , j ) = ( V ( i - 1 , j ) \cdot hb - b , V ( i , j - 1 ) \cdot wb - b , V ( i - 1 , j ) \cdot hb - b + {T}_{O} , V ( i , j - 1 ) \cdot wb - b + {T}_{O} ) \\ V ( i , j ) = ( V ( i - 1 , j ) \cdot hb , V ( i , j - 1 ) \cdot wb , V ( i - 1 , j ) \cdot hb - 2 b + {T}_{O} , V ( i , j - 1 ) \cdot wb - 2 b + {T}_{O} )\end{matrix}$$

$$\begin{matrix}Right boundary tiles : \\ O ( i , lastj ) = ( V ( i - 1 , lastj ) \cdot hb - b , {W}_{O} - {T}_{O} , V ( i - 1 , lastj ) \cdot hb - b + {T}_{O} , {W}_{O} ) \\ V ( i , lastj ) = ( V ( i - 1 , lastj ) \cdot hb - b , {W}_{O} - {T}_{O} + b , V ( i - 1 , lastj ) \cdot hb - 2 b + {T}_{O} , {W}_{O} )\end{matrix}$$

$$\begin{matrix}Bottom boundary tiles : \\ O ( lasti , j ) = ( {H}_{O} - {T}_{O} , V ( lasti , j ) \cdot wb - b , {H}_{O} , V ( lasti , j - 1 ) \cdot wb - b + {T}_{O} ) \\ V ( lasti , j ) = ( {H}_{O} - {T}_{O} + b , V ( lasti , j ) \cdot wb , {H}_{O} , V ( lasti , j - 1 ) \cdot wb - 2 b + {T}_{O} )\end{matrix}$$

According to the first algorithm described above, the system 100 can generate valid fixed-size outputs with valid regions next to each other without overlapping. More specifically, the system 100 can discard pixels in the dummy regions and combine the valid regions in the fixed-size outputs to generate the final output. Moreover, because the valid regions between the fixed-size outputs do not overlap, the system using the first algorithm can compute almost every pixel in the valid regions for only once, which optimizes computation efficiency for FCN models without transposed convolution layer. One example of this implementation is described in more detail in connection with FIG. 3B.

For FCN models including transposed convolution layers, the system 100 needs to perform the second algorithm, which addresses the alignment information. The valid regions generated using the second algorithm can potentially overlap and can cause redundant computations for one or more pixels in valid regions.

The system 100 can obtain alignment information for fixed-size outputs according to the computation requirements set forth by transposed convolution layers in FCN model. For example, the requirement can be that the pixel indices for one or more pixels in the fixed-size input traced from one or more pixels in the fixed-size output should be integers.

The second algorithm reads as follow:

$$\begin{matrix}Initialize : \\ O ( 0 , 0 ) = ( 0 , 0 , {T}_{O} , {T}_{O} ) \\ V ( 0 , 0 ) = ( 0 , 0 , {T}_{O} - b , {T}_{O} - b )\end{matrix}$$

$$\begin{matrix}Left boundary tiles : \\ {U}_{O} = ( V ( i - 1 , 0 ) \cdot hb - b , 0 , V ( i - 1 , 0 ) \cdot hb - b + {T}_{O} , {T}_{O} ) \\ O ( i , 0 ) = AlignOutputTile ( {U}_{o} ) \\ V ( i , 0 ) = ( O ( i , 0 ) \cdot ht + b , 0 , O ( i , 0 ) \cdot hb - b , {T}_{O} - b )\end{matrix}$$

$$\begin{matrix}Top boundary tiles : \\ {U}_{O} = ( 0 , V ( 0 , j - 1 ) \cdot wb - b , {T}_{o} , V ( 0 , j - 1 ) \cdot wb - b + {T}_{O} ) \\ O ( 0 , j ) = AlignOutputTile ( {U}_{O} ) \\ V ( 0 , j ) = ( 0 , O ( 0 , j ) \cdot wt + b , {T}_{o} - b , O ( 0 , j ) \cdot wb - b )\end{matrix}$$

$$\begin{matrix}Internal tiles : \\ {U}_{O} = ( V ( i - 1 , j ) \cdot hb - b , V ( i , j - 1 ) \cdot wb - b , V ( i - 1 , j ) \cdot hb - b + {T}_{O} , V ( i , j - 1 ) \cdot wb - b + {T}_{O} ) \\ O ( i , j ) = AlignOutputTile ( {U}_{O} ) \\ V ( i , j ) = ( O ( i , j ) \cdot ht + b , O ( i , j ) \cdot wt + b , O ( i , j ) \cdot hb - b , O ( i , j ) \cdot wb - b )\end{matrix}$$

The second algorithm is a modified version of the first algorithm. In particular, the system 100 can obtain coordinates of an “unaligned” fixed-size output that does not consider the alignment requirements. The fixed-size output has both a dummy region and valid region with the left and top dummy regions being omitted, denoted as U_{O}. The second algorithm can determine alignment information for the “unaligned” fixed-size outputs and determine whether the “unaligned” fixed-size output satisfies the alignment information based on the AlignOutputTile( ) function below. The alignment information can be obtained using the AlignOutputTile( ) function based on at least one of the local search or analytical method. The alignment information can include coordinate shifts for shifting the “unaligned” fixed-size output leftward and upward. In some implementations, the alignment information can represent alignment values determined based on characteristics of the FCN model analytically. The details of the alignment values and the function for obtaining the alignment values are described below.

By performing the second algorithm, the system 100 can ensure each pixel value associated with the final output can be obtained from at least one of the fixed-size outputs, and the alignment values for the fixed-size outputs can guarantee that each corresponding fixed-size input has integral pixel coordinates with respect to the input image. The system 100 can then obtain the coordinates of the valid region by subtracting the dummy region using the second algorithm.

The details of tiling and stitching process using the first and second algorithms are described in connections with FIGS. 3B and 3C, respectively.

The system 100 can also obtain coordinates of a fixed-size input based on the coordinates of a corresponding fixed-size output using the characteristics of the deployed FCN model. More specifically, the system 100 can obtain the coordinates of a layer input based on the coordinates of a layer output, and the padding, stride, filter size, and scale factor of the layer. One example algorithm is called “ProjectBackwards( )” which reads as follows:

```
  function ProjectBackwards((ht, wt, hb, wb), layers):
    for layer = output to input layers:
      if ht == hb or wt == wb:
        THROW EXCEPTION; // layer is vanished
      if layer type is “conv”:
        // Conv layer: n = floor((m + 2 p − f) / s) + 1, n is output size, m = input size
        s = stride of layer; p = padding of layer; f = filter size of layer
        n_h = hb − ht; n_w = wb − wt //output tile sizes in the h and w dims
        // input tile size
        m_h = (n_h − 1) * s + f − 2 p; m_w = (n_w − 1) * s + f − 2p
          // Note: m_h x m_w is the smallest input tile size, but any size up to
          // (m_h + s − 1) x (m_w +s − 1) will work to produce n_h x n_w output.
          // Selecting a larger size may matter if a trans_conv layer
          // precedes the conv layer in model order and disallows certain sizes.
          // Sizes can be explored as back-tracking, not shown here for simplicity.
        ht = ht * s; hb = ht + m_h
        wt = wt * s; wb = wt + m_w
      else if layer type is “trans_conv”:
        // TransConv layer: n = (m + 2 p − 1) * s + f
        s = stride of layer; p = padding of layer; f = filter size of layer
        n_h = hb − ht; n_w = wb − wt //output tile sizes in the h and w dims
        // input tile size
        m_h = Validate( (n_h − f) / s − 2 p + 1 )
        m_w = Validate( (n_w − f) / s − 2 p + 1 )
        ht = Validate( ht / s ); hb = ht + m_h
        wt = Validate( wt/s ); wb = wt + m_w
    return (ht, wt, hb, wb)
where:
function Validate(value):
  if value is integral:
    return value
  else: THROW EXCEPTION
  // Value cannot be used for coordinates of a fixed-size input in an FCN.
```

The ProjectBackwards( ) algorithm calls the Validate ( ) function to check whether the coordinates of a fixed-size input can be properly projected from an output of a layer to an input of the layer. This Validate ( ) function can determine, for example, if the output location (e.g., pixel coordinates) chosen by the system 100 are not proper for the alignment constraints or alignment information for one or more transposed convolutional layers (i.e., the projected coordinates include non-integer values), and therefore the output location that system 100 attempts to project back to the fixed-size input location is invalid and cannot be used.

In some implementations, the system 100 can also obtain coordinates for a fixed-size output based on the coordinates of a corresponding fixed-size input and the characteristics of the deployed FCN model. One example algorithm is called “ProjectForward( )” which reads as follows:

```
function ProjectForward((ht, wt, hb, wb), layers):
  for layer = input to output layers:
    if ht == hb or wt == wb:
      THROW EXCEPTION; // layer is vanished
    if layer type is “conv”:
      // Conv layer: n = floor((m + 2 p − f) / s) + 1, n is output size, m = input size
      s = stride of layer; p = padding of layer; f = filter size of layer
      m_h = hb − ht; m_w = wb − wt // input tile sizes in the h and w dims
      // output tile size
      n_h = floor((m_h + 2p − f) / s) + 1;
      n_w =floor((m_w + 2 p − f) / s) + 1
      ht = Validate( ht / s ); hb = ht + n_h
      wt = Validate( wt / s ); wb = wt + n_w
    else if layer type is “trans_conv”:
      // TransConv layer: n = (m + 2 p − 1) * s + f
      s = stride of layer; p = padding of layer; f = filter size of layer
      m_h = hb − ht; m_w = wb − wt // input tile sizes in the h and w dims
      // output tile size
      n_h = (m_h + 2 p − 1) *s + f; n_w = (m_w + 2 p − 1) *s + f;
      ht = ht * s; hb = ht + n_h
      wt = wt * s; wb = wt + n_w
  return (ht, wt, hb, wb)
```

Similarly, the Validate ( ) function can be used by the ProjectForwards( ) algorithm to validate the projection of an fixed-size input location to its corresponding output location, and can determine, for example, if the fixed-size input location for a convolutional layer with a stride size greater than one is not suitable.

Referring back to FIGS. 3A and 3D, the system can determine a width b for a dummy region such that the region of width b should at least include all the inaccurate pixels. In some implementations, the dummy region can include all inaccurate pixels and one or more accurate pixels. However, the width b should not be too large to harm the computation performance because a large width b can result in the system 100 producing a greater number of overlapping fixed-size outputs and fixed-size inputs during the tiling and stitching process. The system 100 can determine a minimal value for the width b by calculating the first valid pixel offset for layer output of each layer. The first valid pixel for the current layer is calculated by the system 100 without using any zero-value neighbor pixels from the output of a preceding layer. The system 100 performs operations of the function FirstValidPixelOffset( ) as below:

```
function FirstValidPixelOffset(layers):
  // First pixel offset at which the prior layer produced a valid result.
  first_valid_offset = 0
  for layer = input to output layers:
    if layer type is “conv”:
      s = stride of layer; p = padding of layer; f = filter size of layer
      first_valid_offset = ceil((first_valid_offset + p) / s)
    else if layer type is “trans_conv”:
      s = stride of layer; p = padding of layer; f = filter size of layer
      // Offset of last invalid pixel on the input activation. Can be −1 or greater.
      last_invalid_offset = first_valid_offset + p − 1
      // Offset of last invalid pixel on the output activation.
      last_invalid_offset = last_invalid_offset * s +f − 1
      first valid offset = last_invalid_offset + 1
  return first_valid_offset
b=FirstValidPixelOffset(layers)
```

It is noted that in general, the criteria for the first valid pixel calculated from the left and the right of a fixed-size output is not entirely symmetrical—a few pixels may remain on the right side of the fixed-size input where the filter could not be applied, which keeps one more valid pixel on the right side of the fixed-size output than the left. The output (e.g., the first valid offset) of the FirstValidPixelOffset( ) function is calculated from the left, and this value should also be correct for the right. Similarly, the above-described analysis should also apply for calculations from the top or the bottom of the fixed-size output.

Referring back to the AlignOutputTile( ) function in the second algorithm and in connection with the ProjectBackwards( ) function, the system 100 can obtain a respective coordinate shift for each of the respective fixed-size outputs, and generate a final output by combining the respective fixed-size outputs based on respective coordinate shifts.

The system 100 can implement the AlignOutputTile( ) function using different methods. To name just a few examples, the system 100 can perform a local search for the respective coordinate shifts, or obtain analytical expressions for the respective coordinate shifts. The AlignOutputTile( ) reads as follows:

```
function AlignOutputTile( (ht, wt, hb, wb), layers):
  if approach == “local search”:
    for (hs, ws) = try all values in some pattern from 0 to max_shift:
      try:
        return ProjectBackwards( (ht − hs, wt−ws, hb−hs, wb−ws), layers )
      except:
        // Failed to project, keep trying with other shift values.
    THROW EXCEPTION // failed to find valid alignment for tile
  else if approach == “analytical”:
    hts = int (ht / alignment) * alignment
    wts = int (wt / alignment) * alignment
    hbs =hb − (ht − hts)
    wbs =wb − (wt − wts)
    return (hts, wts, hbs, wbs)
where: alignment = CalculateAnalyticalAlignment(layers)
```

When using local search method, the system 100 can provide a plurality of trial shift values in each dimension. The trial shift values can range from zero pixel to a predetermined maximum value for a coordinate shift (e.g., the size of the final output). The system 100 needs to determine a relation between the coordinates of an “unaligned” fixed-size output and the coordinates of the associated fixed-size input. As an example, the system 100 can provide the coordinates of the “unaligned” fixed-size output 133 and the trial shift values into the ProjectBarckwards( ) function to search for a validated fixed-size input (i.e., the coordinates representing the fixed-size input should fall on integral pixels). Once the system 100 successfully finds the validated fixed-size input, the system 100 can return the shifted fixed-size output based on the particular trial shift value.

When using analytical method, the system 100 can determine a constant alignment value by analyzing the characteristics of the deployed FCN model. One example algorithm for the analytical expressions is called “CalculateAnalyticalAlignment( )” which reads as follows:

function CalculateAnalyticalAlignment( layers ):
// Algo to find the smallest correct alignment: presence of conv layers before trans_conv
// layers eases the alignment needed by the trans_conv layers.

| | |
|---|---|
| conv_stride_product = 1 | // product of strides of back-to-back conv layers |
| trans_conv_stride_product = 1 | // product of strides of back-to-back trans conv layers |
| alignment = 1 | // required tile alignment at the FCN output layer |

```
  for layer = output to input layers:
    if layer type is “conv”:
      s = stride of layer
      conv_stride_product *= s
    else if layer_type is “trans_conv”:
      s = stride of layer
      trans_conv_stride_product *= s
      prev_layer = previous layer //prev_layer produces the input for layer
      // prev_layer == null if layer is the input layer for the whole FCN.
      if prev_layer == null OR prev_layer type != “trans_conv”:
        // utilize the subsequent stack of conv layers to ease the
        // alignment requirement imposed by a stack of trans_conv layers by using the
greatest common divisor
        gcd = GCD (conv_stride_product, trans_conv_stride_product)
alignment_for_stack = trans_conv_stride_product / gcd
        alignment *= alignment_for_stack
        // Reset stacks
        conv_stride_product, trans_conv_stride_product = 1, 1
  return alignment
```

The system 100 determines the constant alignment value based on the characteristics of each layer of the FCN model. For example, the characteristics can be a layer type (e.g., convolutional, transpose convolution layer, or other layer such as pooling layer), or a size for padding, filter, and stride for the layer. As described earlier, other types of layers in the FCN model, e.g., pooling layers, are treated as a convolution layer for throughout the specification.

FIG. 3B illustrates an example of tiling and stitching process 399 performed by the example inference system 100 of FIG. 1. The system 100 can be configured to perform the tiling and stitching process 355 using the first algorithm.

The system 100 can generate multiple fixed-size inputs 350a, 350b, 350c, and 350d with respective sizes. For example, the fixed-size inputs 350a-d can each have a different size. As another example, the fixed-size inputs 350a-d can have the same size, as shown in FIG. 3B. For ease of illustration, the fixed-size inputs 350a-d are represented in squares with solid lines.

As shown in FIG. 3B, the each fixed-size inputs 350a-d can have a respective neighbor pixel regions 360a, 360b, 360c, or 360d. The size or width of the neighbor pixel regions can be one pixel, three pixels, and five pixels. For ease of illustration, the neighbor pixel regions are presented in squares with dashed lines. It is noted that the left region of the zero-pixel-value region 360a does not include any zero-value neighbor pixels, because the left edge of the fixed-size input 350a is also a portion of the left edge of the full input data 150, such that the computation processing of pixels in the left region of the fixed-size input 350a does not introduce inaccuracy to the corresponding fixed-size output.

In some implementations, the fixed-size inputs 350a-d and respectively associated neighbor pixel regions 360a-d can be uniformly spaced with respect to the full input data 150 and uniformly overlap each other. As shown in FIG. 3B, the fixed-size inputs 350a and 350b overlap each other in the overlapping region 353a, the fixed-size inputs 350b and 350c overlap each other in the region 353b, and the fixed-size inputs 350c and 350d overlap each other in the region 353c. The overlapping regions 353a and 353b have the same size, but the overlapping region 353c can be greater than the overlapping regions 353a and 353b. This is due to the characteristics of the first algorithm. As shown in the first algorithm, fixed-size inputs on the right boundary and bottom boundary cannot exceed the boundaries of an input data. For example, assuming the fixed-size input 350d is arranged in the same manner as the other fixed-size inputs 350a-c, the fixed-size input 350d is on the right boundary and can have a portion exceeding the right boundary of the full input data 150. The system 100, using the first algorithm, can “translate” (i.e., re-tile) the fixed-size input 350d a few pixels to the left so that the pixels of the fixed-size input 350d are located entirely inside the full input data 150. However, since the arrangement of the fixed-size input 350d is no longer the same as other fixed-size inputs, the overlapping region 353c between the fixed-size inputs 350d and 350c can be greater than the overlapping regions 353a and 353c. When the fixed-size inputs on the right and bottom boundaries do not exceed the corresponding boundaries of the full input data 150, the fixed-size inputs can be arranged to have the same overlapping regions.

After tiling the full input data 150 into multiple fixed-size inputs based on a fixed size calculated online or offline, the system 100 can process random-size inputs and generate fixed-size outputs with respective valid regions that do not overlap each other and abut each other on the edge pixels based at least on the first algorithm and a stitching algorithm, which will be described in more details below.

The system 100 can generate fixed-size outputs with valid regions that generally do not overlap each other in the full output data 170. However, in some situations, one or more fixed-size outputs can overlap with each other. As shown in FIG. 3B, the valid regions 370a, 370b, and 370c do not overlap each other. However, the valid region 370d overlaps the valid region 370c in an overlapping region 373. This is because the first algorithm can “translate” the right-boundary fixed-size input 350a to the left by a few pixels using the first algorithm, so that the fixed-size outputs 370d overlaps with the neighboring fixed-size output 370c. The dummy regions 375a, 375b, 375c, and 375d associated with a corresponding valid region can overlap. For ease of illustration, the valid regions of the fixed-size outputs are represented in squares with solid lines, and the dummy regions of the fixed-size outputs are represented in squares with dashed lines.

The left region of the dummy region 375a does not include any invalid values because the left edge of the fixed-size output 375a is also a portion of the left edge of the full output data 170. Similarly, the right edge of the dummy region 375d does not include any invalid values.

During the stitching process, the system 100 can discard the pixel-wise values in the dummy regions, and connects the pixel-wise values in the valid regions to generate the full output data 170. Each pixel value in the full output data (or the final output) is provided at least once from all the pixel-wise values in the valid regions.

FIG. 3C illustrates another example of tiling and stitching process 355 performed by the example inference system 100 of FIG. 1. The system 100 can be configured to perform the tiling and stitching process 399 using the second algorithm.

Comparing to the first algorithm, as described above, the system 100 performs a few additional steps using the second algorithm, e.g., determining alignment information for the FCN model and determine valid regions by calculating coordinate shifts for the fixed-size outputs based on the alignment information. This is because when an FCN model includes particular layers (e.g., transposed convolution layers), the system needs to validate mapping (e.g., integer coordinates) from pixels in a fixed-size output to corresponding pixels in a fixed-size input.

In addition, the second algorithm is different from the first algorithm by not needing to perform “translations” of fixed-size outputs on the right or bottom boundary of the full input data 150.

As shown in FIG. 3C, the system 100 can generate multiple fixed-size inputs (e.g., fixed-size inputs 380a-d) from the full input data 150 based on a tiling pattern. The fixed-size inputs 380a-d can overlap with each other of a respective sizes or of the same size. For example, the fixed-size input 380a and the second fixed-size input 380b can overlap each other in an overlapping region 385a, the second fixed-size input 380b and the third fixed-size input 380c can overlap each other in an overlapping region 385b, and the third fixed-size input 380c and the fourth fixed-size input 380d can overlap each other in an overlapping region 385c. The size of the overlapping regions 385a-c are substantially the same, as shown in FIG. 3C. In some implementations, the overlapping regions 385a-c can be slighter greater than overlapping regions generated using the first algorithm. This is because the system using the second algorithm needs to tile fixed-size inputs based on the alignment information.

The system 100 can also determine and arrange zero-value neighbor pixel regions 390a-d similar to those described above. As shown in FIG. 3C and for the ease of illustration, fixed-size inputs 380a, 380b, 380c, and 380d are represented by squares of solid lines, and the neighbor pixel regions 390a, 390b, 390c, and 390d are represented by squares of dashed lines.

The system 100 can determine a region outside the full input data 150 using the second algorithm, and might not need to “translate” the fixed-size input 380d. As shown in FIG. 3C, the fixed-size input 380d has a region 381 outside the full input data 150. The overlapping regions 385a-c can maintain to be the same because the fixed-size input 380d is not “translated.” The second algorithm is more robust than the first algorithm when processing particular inputs where “translation” operations are not permitted.

After processing all of the fixed-size inputs through the compiled FCN model, the system 100 can determine the valid regions 395a, 395b, 395c, and 395d and corresponding dummy regions 397a, 397b, and 397c of all the fixed-size outputs, calculate coordinate shifts for the pixels in the valid regions according to the second algorithm, discard pixels in the dummy regions, and combine the pixels in the valid regions to generate the full output data 170. The valid regions 395a-d can also overlap with each other in respective overlapping regions 393a-c. The respective overlapping regions 393a-c can be substantially the same when the overlapping regions 385a-c between fixed-size inputs ae substantially the same.

Similarly, for ease of illustration, the valid regions of the fixed-size outputs 395a-d are represented by squares of solid lines, and the dummy regions of the fixed-size outputs 397a-d are represented by squares of dashed lines.

It is noted that, while there are only four fixed-size inputs and four fixed-size outputs shown in FIGS. 3B and 3C, it should be appreciated that the system 100 can generate more than four fixed-size inputs for tiling the full input data 150, e.g., 5, 10, 20, 50, and more. The system can also generate more than four fixed-size outputs that include valid pixel-wise values for each pixel in the full output data 170, e.g., 5, 10, 20, 50, and more. Each pixel-wise value for a pixel associated in the full output data 170 is at least represented in a fixed-size output generated from a corresponding fixed-size input. For a pixel-wise value of a pixel in the overlapping regions across two or more fixed-size outputs, the system 100 can select, as the pixel-wise value for the pixel, a corresponding pixel value from any one of the overlapping fixed-size outputs.

After computing all the fixed-size outputs through the FCN model, the system can apply the O(i,j) and V(i,j) mappings to construct a full output as if the input were entirely processed by the FCN model, using StitchOutputImage( ) function as follows:

```
function StitchOutputImage( ):
  for tile indices (i,j)in a top-to-bottom, left-to-right scan of the tiles:
    (ht_O, wt_O, hb_O, wb_O) = O(i,j)
    (ht_V, wt_V,hb_V, wb_V) = V(i,j)
    Output(ht_V:hb_V, wt_V:wb_V) = OutputTile( (ht_V−ht_O):(hb_V−ht_O), (wt_V−
wt_O):(wb_V−wt_O) )
```

The OutputTile(i,j) represents the fixed-size output of size T_{O} corresponding to the (i,j)^{th} fixed-size input. For example, a fixed-size input in the i^{th} column and j^{th} row of a tiling grid.

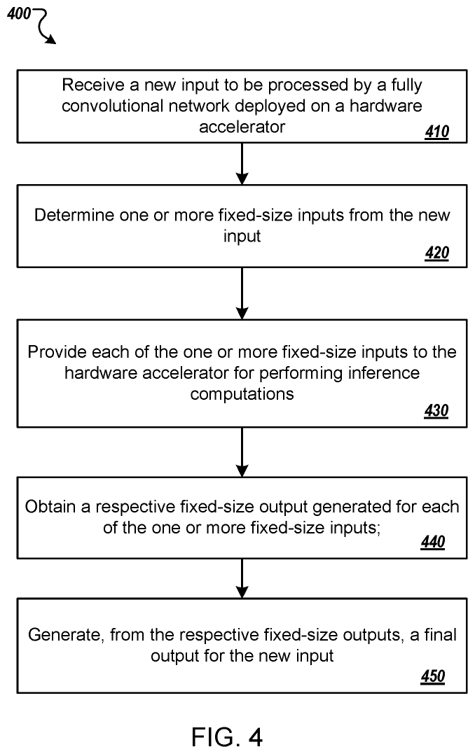

FIG. 4 illustrates an example process 400 for performing inference computations of a fully convolutional network for inputs with different sizes. For convenience, the process 400 is described as being performed by a system of one or more computers located in one or more locations. For example, a neural inference system, e.g., the system 100 of FIG. 1, appropriately programmed, can perform the process 400.

The system receives a new input to be processed by a fully convolutional neural network deployed on a hardware accelerator. (410) The new input can have a first size different from a fixed size that the fully convolutional neural network is configured to process when deployed on the hardware accelerator. As described above, the new input can have a size greater than the fixed size, or smaller than the fixed size.

The system determines one or more fixed-size inputs from the new input. (420) Each fixed-size input of the one or more fixed-size inputs has the fixed size. More specifically, the system can determine a tiling pattern for tiling the new input based at least on the characteristics of the deployed FCN model, e.g., alignment information, padding sizes, stride sizes, filter sizes, and scale factors.

The system provides each of the one or more fixed-size inputs to the hardware accelerator for performing inference computations using the fully convolutional neural network. (430)

The system obtains, from the hardware accelerator, a respective fixed-size output generated by the fully convolutional neural network for each of the one or more fixed-size inputs. (440) The respective fixed-size outputs can include one or more inaccurate pixel-wise results. As described above, the system can include a host to provide the fixed-size inputs for the deployed FCN on the hardware accelerator, and receive the fixed-size outputs from the hardware accelerator. The system can use neighbor pixels surrounding the fixed-size inputs when processing the fixed-size inputs, and determine a valid region and a dummy region for each fixed-size output.

The system generates, from the respective fixed-size outputs, a final output that is equivalent to an output that would be generated by processing the new input using the fully convolutional neural network. (450)

As described above, the system can combine the fixed-size outputs using different algorithms based on the characteristics of the deployed FCN. If the FCN model does not include any transpose convolution layer, the system can combine valid regions of each fixed-size output using the first algorithm. If the FCN model includes one or more transpose convolution layers, the system can combine fixed-size outputs by obtaining coordinate shifts for each fixed-size output, and shifting coordinates of each fixed-size output based on the coordinate shifts.

The system can determine a coordinate shift using different methods. For example, the system can determine a coordinate shift using local search. The system can generate a coordinate shift for a fixed-size output by testing a plurality of trial shift values using the ProjectBackwards( ) function. Alternatively, the system can generate a coordinate shift based on analyzing the characteristics of a deployed FCN, and obtain constant values for coordinate shifts by analytical expressions using the “CalculateAnalyticalAlignment( )” function.

Implementations of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, implementations of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being or may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving a new input to be processed by a fully convolutional neural network deployed on a hardware accelerator, the new input having a first size that is different from a fixed size that the fully convolutional neural network is configured to process when deployed on the hardware accelerator;
determining, one or more fixed-size inputs from the new input, each fixed-size input having the fixed size;
providing each of the one or more fixed-size inputs to the hardware accelerator for performing inference computations using the fully convolutional neural network;
obtaining, from the hardware accelerator, a respective fixed-size output generated by the fully convolutional neural network for each of the one or more fixed-size inputs, wherein the respective fixed-size outputs comprise one or more inaccurate pixel-wise results; and
generating, from the respective fixed-size outputs, a final output that is equivalent to an output that would be generated by processing the new input using the fully convolutional neural network.

2. The method of claim 1, further comprising:
prior to deploying the fully convolutional neural network on the hardware accelerator, determining the fixed size based at least on characteristics of the fully convolutional neural network.

3. The method of claim 2, wherein determining the fixed size further comprises:
providing a plurality of candidate sizes to a user for selecting one candidate size of the plurality of candidate sizes as the fixed size.

4. The method of claim 1, further comprising:
generating a plurality of candidate sizes for the fully convolutional neural network based on the characteristics of the fully convolutional neural network;
for each of the candidate sizes:
deploying a copy of the fully convolutional neural network on a respective hardware accelerator for processing inputs of the candidate size;
measuring a total execution time of performing inference computations for the deployed copy of the fully convolutional neural network on the respective hardware accelerator;
selecting, as the fixed size, a candidate size from the plurality of candidate sizes based at least upon the measured total execution times for the candidate sizes.

5. The method of claim 1, wherein determining the fixed size further comprises:
determining that the first size of the new input is smaller than the fixed size; and
generating a fixed-size input by padding zeros around the new input up to the fixed size.

6. The method of claim 1, wherein each of the respective fixed-size outputs comprises a central valid region, and a peripheral dummy region at a width of a first number of pixels, wherein the central valid region includes at least a portion of the final output, wherein the peripheral dummy region comprises one or more inaccurate pixel-wise results;

7. The method of claim 6, wherein the first number of pixels is determined based on characteristics of the fully convolutional neural network.

8. The method of claim 6, wherein generating the final output from the respective fixed-size outputs, comprises:
combining the central valid regions of the respective fixed-size outputs based on relations between coordinates of the respective fixed-size outputs and coordinates of respective corresponding fixed-size inputs used for generating the respective fixed-size outputs.

9. The method of claim 8, wherein combining the respective fixed-size outputs further comprises:
determining data representing a respective coordinate shift for each of the respective fixed-size outputs; and
combining the central valid regions of the respective fixed-size outputs based on the determined data.

10. The method of claim 9, wherein determining data representing the respective coordinate shift comprises:
determining the respective coordinate shift using local search, wherein the local search comprises determining a relation between coordinates of a fixed-size output and coordinates of a corresponding fixed-size input used for generating the fixed-size output.

11. The method of claim 9, wherein determining data representing the respective coordinate shift comprises:
determining, based on characteristics of the fully convolutional neural network, overall alignment information; and
determining, based on the determined overall alignment information, the respective coordinate shift for each of the respective fixed-size outputs.

12. The method of claim 11, wherein the characteristics of the fully convolutional neural network comprises: a respective filter size, zero padding size, stride size, and scale factor for each network layer of the fully convolutional neural network.

13. A system comprising one or more computers and one or more storage devices storing instructions that, when executed by the one or more computers, cause the one or more computers to perform operations comprising:
receiving a new input to be processed by a fully convolutional neural network deployed on a hardware accelerator, the new input having a first size that is different from a fixed size that the fully convolutional neural network is configured to process when deployed on the hardware accelerator;
determining, one or more fixed-size inputs from the new input, each fixed-size input having the fixed size;
providing each of the one or more fixed-size inputs to the hardware accelerator for performing inference computations using the fully convolutional neural network;
obtaining, from the hardware accelerator, a respective fixed-size output generated by the fully convolutional neural network for each of the one or more fixed-size inputs, wherein the respective fixed-size outputs comprise one or more inaccurate pixel-wise results; and
generating, from the respective fixed-size outputs, a final output that is equivalent to an output that would be generated by processing the new input using the fully convolutional neural network.

14. The system of claim 13, wherein the operations further comprise:
prior to deploying the fully convolutional neural network on the hardware accelerator, determining the fixed size based at least on characteristics of the fully convolutional neural network.

15. The system of claim 14, wherein determining the fixed size further comprises:
providing a plurality of candidate sizes to a user for selecting one candidate size of the plurality of candidate sizes as the fixed size.

16. The system of claim 13, wherein the operations further comprise:
generating a plurality of candidate sizes for the fully convolutional neural network based on the characteristics of the fully convolutional neural network;
for each of the candidate sizes:
deploying a copy of the fully convolutional neural network on a respective hardware accelerator for processing inputs of the candidate size;
measuring a total execution time of performing inference computations for the deployed copy of the fully convolutional neural network on the respective hardware accelerator;
selecting, as the fixed size, a candidate size from the plurality of candidate sizes based at least upon the measured total execution times for the candidate sizes.

17. The system of claim 13, wherein determining the fixed size further comprises:
determining that the first size of the new input is smaller than the fixed size; and
generating a fixed-size input by padding zeros around the new input up to the fixed size.

18. The system of claim 13, wherein each of the respective fixed-size outputs comprises a central valid region, and a peripheral dummy region at a width of a first number of pixels, wherein the central valid region includes at least a portion of the final output, wherein the peripheral dummy region comprises one or more inaccurate pixel-wise results;

19. The system of claim 18, wherein the first number of pixels is determined based on characteristics of the fully convolutional neural network.

20. One or more non-transitory computer storage media storing instructions that, when executed by one or more computers, cause the one or more computers to perform operations comprising:
receiving a new input to be processed by a fully convolutional neural network deployed on a hardware accelerator, the new input having a first size that is different from a fixed size that the fully convolutional neural network is configured to process when deployed on the hardware accelerator;
determining, one or more fixed-size inputs from the new input, each fixed-size input having the fixed size;
providing each of the one or more fixed-size inputs to the hardware accelerator for performing inference computations using the fully convolutional neural network;
obtaining, from the hardware accelerator, a respective fixed-size output generated by the fully convolutional neural network for each of the one or more fixed-size inputs, wherein the respective fixed-size outputs comprise one or more inaccurate pixel-wise results; and
generating, from the respective fixed-size outputs, a final output that is equivalent to an output that would be generated by processing the new input using the fully convolutional neural network.
